(19) United States
(12) Patent Application Publication
(10) Pub. No.: US 2012/0131103 A1
(43) Pub. Date: May 24, 2012

(54) SYSTEM AND METHOD FOR TRANSMISSION AND RECEPTION OF CONTENT

(75) Inventor: Arthur C. Fox, Randolph, NJ (US)

(73) Assignee: Innovation Global Network Limited Liability Company, Mt. Freedom, NJ (US)

(21) Appl. No.: 13/296,512

(22) Filed: Nov. 15, 2011

Related U.S. Application Data
(60) Provisional application No. 61/415,327, filed on Nov. 18, 2010.

(51) Int. Cl. G06F 15/16

(52) U.S. Cl. 709/204

(57) ABSTRACT

Embodiments of the present invention generally relate to a system and method for the transmission and reception of content. In accordance with an embodiment of the present invention, a system and method for the transmission and reception of content implemented in a computer server is provided comprising: receiving a submission from a user; receiving an indication of at least one destination of the submission from the user; transmitting the submission to at least one destination, wherein the at least one destination may comprise any device configured to receive data, any computer system configured to receive data, or the like.

### CROSS-REFERENCE TO RELATED APPLICATIONS

This application claims the benefit of U.S. Provisional Application Ser. No. 61/415,327, filed Nov. 18, 2010, entitled “System and Method for Transmission and Reception of Content,” which is incorporated herein by reference in its entirety.

### BACKGROUND

1. Field of the Invention

The following generally relates to a system and method for the transmission and reception of content. More specifically, embodiments of the present invention relate to a system and method for viral opportunity growth related to the transmission and reception of content between businesses, organizations, affinity groups, businesses and individuals, any and all combinations thereof, and the like.

2. Description of Related Art

In order to remain competitive, corporate professionals constantly seek ways to learn about industry best practices so they can identify individuals who can best help their business needs. By identifying what the industry best practices are and the individuals engaged in these practices, corporate professionals can learn how to drive innovation, sales and growth with respect to their companies.

Today, consultants, agencies, and other corporate professionals are having an increasingly difficult time interacting with all of their contacts. Many agencies and consultants have hundreds, thousands, or even hundreds of thousands of business contacts. However, the reality is that the majority of these agencies and consultants interact with only 5-10% of their contacts. In fact, it is not uncommon that these consultants and agencies fail to engage in any type of interaction with at least 90% of their contacts in the previous couple of years.

To counteract this problem, the Internet is being increasingly used as a platform for business and personal communication. Many businesses and individuals implement systems and methods for transmitting and receiving content utilizing Internet or “online” platforms and technologies. For example, many businesses and individuals use online technologies to share opinions, insights, experiences, perspectives, or the like. Examples of online technologies for business and personal communication include social networks, blogging systems, media sharing platforms, online forums, aggregators, e-mail systems, chat systems, or discussion threads.

A common theme among existing systems and methods for transmitting and receiving content is these systems and methods tend to rely upon simple submissions to a web page or to a forum that enables members or visitors to review the submission and post comments or replies in response to the submission. For example, networking websites such as LinkedIn allow a user to create a profile directed towards a professional business environment, add contacts to the user's network, and send messages/replies to other contacts.

One limitation of many current systems and methods for transmitting and receiving content is that most networking websites allow only registered users of the website to view and post content or comments. Another limitation of these systems and methods is that existing networking websites and groups tend to only allow the registered users' contacts, “friends,” or group members of the website the ability to view and reply to content submitted by the registered user. Another limitation of existing systems and methods for transmitting and receiving content is that many current systems and methods only allow the capability to interact with others between and among the registered users' contacts or “friends.”

Current systems and methods for transmitting and receiving content have attempted to solve the restricted membership limitation by encouraging posting links to content on other sites with the objective of building traffic back to the original site. Some socially oriented blogs and network sites enable the posting of links to the content on other sites with the objective of building traffic back to the original site. However, the informal and general nature of these submission processes tend to lead to the production of a lot of low value content, spam and “noise”. This discourages companies, organizations, and affinity groups from investing resources in participating in these socially oriented blogs and network sites.

Existing systems and methods for transmitting content, including social media based networks, are also limited because they are either focused purely on networking relationships (for example, “connections” or “friends”) among registered members, or they are designed with a very limited ability to enable employees or members of companies, organizations, or affinity groups to find best practices and other valuable content. In addition, existing systems and methods for transmitting content are limited in the employee, company, organization, or affinity group's ability to engage with the companies, organizations, affinity groups, or individuals in possession of these best practices and other valuable content. This has been a limiting factor and the reason why few companies employ use of these existing systems and methods for transmitting content. Existing systems and methods for transmitting content also either provide limited means to keep proprietary best practice content confidential or claim ownership to the content on these systems thereby depriving the submitters of their ability to permanently control best practice content and/or assure confidentiality. These limitations have constrained the ability of companies to learn and engage other companies with best practices.

Thus, there is a need for an improved system and method for the transmission and reception of content that allows consultants, agencies and corporate professionals to actively engage and interact with a greater number of their contacts.

There is a further need for an improved system and method for the transmission and reception of content to users so a user may relatively easily and quickly push the content to both a much larger and more highly targeted group of relevant individuals, resulting in much greater value being obtained. In addition, there is a need for an improved system and method for the transmission and reception of content wherein cumulative content submissions received from various sources result in a self-perpetuating value circle of new opportunities being created substantially continuously.

Furthermore, there is a need for an improved system and method for the transmission and reception of content that allows consultants, agencies and corporate professionals to interact with unregistered users.

### SUMMARY

Embodiments of the present invention generally relate to a system and method for the transmission and reception of content. More specifically, embodiments of the present invention relate to a system and method for viral opportunity growth related to the transmission and reception of content between businesses, organizations, affinity groups, business and individuals, any combination thereof, or the like.

In accordance with an embodiment of the present invention, there is provided a method for the transmission and reception of content implemented in a central server, comprising: receiving at the central server, from a first user, a content submission; receiving at the central server, from the first user, an indication of at least one destination of the content submission; and transmitting the content submission to at least a second user and the at least one destination.

In another embodiment of the present invention, there is provided a method for providing a growth opportunity based on the transmission and reception of content in a central server, comprising: receiving at the central server, from a first user, an invitation designating a contact list; receiving, from the first user, a content submission; associating the first user with at least a second user from the contact list to create the growth opportunity; and transmitting an alert to at least the second user indicating the growth opportunity.

In yet another embodiment of the present invention, there is provided a system for transmitting and receiving content, comprising: a content submission module configured to receive at a central server, from a first user, a content submission; and a submission process module configured to: receive at the central server, from the first user, an indication of at least one destination of the content submission; and transmit the content submission to at least a second user and the at least one destination.

In an embodiment of the present invention, the at least one destination may comprise at least one of a business, organization, affinity group, contact, a group of businesses, a group of organizations, a group of affinity groups, a group of contacts, a registered company, a group of registered companies, a best practice group, a product group, a service group, a regional group, a community, a business website, an organization website, a group website, a social networking website, a group of social networking websites, a blog, a news feed, any fillable data field, any combination of fillable data fields, any device configured to receive data, any computer system configured to receive data, or the like.

In accordance with yet another embodiment of the present invention, a system and method is provided for creating a viral-growth opportunity for a business group, an organizational group, an affinity group, or a networking group by motivating active recruitment of, and engagement with, colleagues and other users around content submissions of best industry practices and other content.

In accordance with one or more embodiments of the present invention, various systems for transmitting and receiving content are provided, comprising: an invitation module configured to mass invite colleagues to participate in a network and participate in discussions; an initiation module configured to initiate discussions between registered or unregistered users or a set group of registered or unregistered users; a broadcast module configured to broadcast messages to entire contact lists via e-mail, posting, or any electronic message; a reply module configured to allow registered or unregistered users to reply to community messages, group messages, or forum messages; a publishing module configured to publish content across news and blog aggregation websites; a registration module configured to allow users to register for premium groups and memberships; a profile module configured to allow users to create a company profile, an organization profile, or a personal profile; a contact network creation module configured to allow users to create a contact network of registered and/or unregistered users using contact e-mail addresses; a request module configured to allow users to submit requests for proposals and opportunities; a linking module configured to allow registered users to link to other registered or unregistered users via a “contact networking” process; and a meeting registration module configured to register users to webinars, seminars, workshops, conferences, or the like.

In accordance with another embodiment of the present invention, a system and method for the transmission and reception of content may comprise a set of computer implemented instructions, comprising: creating specific company pages; creating industry pages; creating specific company best practices pages; creating user communities; creating user groups; posting advertisements; posting business announcements; posting organization announcements; posting group announcements; and allowing users to receive information from syndicated news feeds and blog aggregation websites. In accordance with yet another embodiment of the present invention, user groups may comprise, for example, a Brainstorming Community, a Geocentric Innovation Community, a Food Innovation Community, or the like.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts an exemplary system for transmitting and receiving content in accordance with an embodiment of the present invention;

FIG. 2 depicts a block diagram of a general computer system, which is capable of being used in connection with the systems depicted in FIGS. 1 and 3, in accordance with another embodiment of the present invention;

FIG. 3 depicts a system-level diagram of a system for transmitting and receiving content in accordance with an embodiment of the present invention;

FIG. 4 depicts a flowchart of a method for the transmission and reception of content from the perspective of an administrator in accordance with the embodiments of the present invention;

FIG. 5 depicts a flowchart of a method for the transmission and reception of content from the perspective of a first user in accordance with the embodiments of the present invention;

FIG. 6 depicts a flowchart of a method for the transmission and reception of content from the perspective of a second user in accordance with the embodiments of the present invention;

FIG. 7 depicts a flowchart of a method for the transmission and reception of content from the perspective of an administrator in accordance with the embodiments of the present invention;

FIGS. 8A-8F depict user interfaces to access various exemplary systems and methods for the transmission and reception of content in accordance with embodiments of the present invention;

FIGS. 9A-9D depict user interfaces to access various exemplary systems and methods for the transmission and reception of content in accordance with embodiments of the present invention;

FIGS. 10A-10H depict user interfaces to access various exemplary systems and methods for the transmission and reception of a content submission in accordance with embodiments of the present invention; and

FIGS. 11A-11D depict user interfaces to access various exemplary systems and methods for the transmission and reception of content in accordance with embodiments of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. To facilitate understanding, like reference numerals have been used, where possible, to designate like elements common to the figures.

### DETAILED DESCRIPTION

Embodiments of the present invention generally relate to a system and method for the transmission and reception of content. More specifically, embodiments of the present invention relate to a system and method for viral opportunity growth related to the transmission and reception of content between businesses, organizations, affinity groups, business and individuals, or the like.

As used herein, the terms “user” or “users” may generally refer to any person, group, entity, or electronic device capable of accessing or communicating with a network or server computer configured in accordance with an embodiment of the present invention and implementing or utilizing any embodiment of the present invention. For example, a “user” may be an individual person, a group of people, a company, a group of companies, other organizations or the like. In accordance with one or more embodiments of the present invention, a user may be a consultant, agency or corporate professional. A “corporate professional” generally refers to any individual employed by a corporation, limited liability company, partnership, sole proprietorship, or the like. In accordance with an embodiment of the present invention, a user may be a governmental, non-profit, or academic professional. In accordance with one or more embodiments of the present invention, a user also may be any electronic device or software program capable of communicating with a network or server computer.

As used herein, the terms “disseminate” or “dissemination” may generally refer to the transmission of information. For example, “disseminate” may refer to causing to be widely known, spreading information, disbursing information, circulating information, broadcasting information, opening a subject for discussion, or the like. In accordance with one or more embodiments of the present invention, “disseminate” may refer to transmitting content or information electronically to a selected or predetermined group of destinations or recipients.

As used herein, the term “content” may generally refer to information stored in an electronic form that can be transmitted and received by electronic communications, for example, via analog, digital, wireless, or the like. Examples of such content includes binary data, structured data (such as data stored in databases), unstructured data (such as image documents), folders, text, video, audio, word processing documents, source code files, object code files, physical documents, physical objects, combinations thereof, or the like.

As used herein, the terms “computer” or “server” refer, generally to devices that may comprise processors, program logic, or other substrate configurations representing data and instructions, which may operate as described herein. In other embodiments, the computers or servers may comprise controller circuitry, processor circuitry, processors, general purpose single-chip or multi-chip microprocessors, digital signal processors, embedded microprocessors, microcontrollers, integrated circuits, application specific integrated circuits, discrete logic, or the like. In yet other embodiments, the computers or servers may comprise hardware, firmware, software and/or other combinations of these to perform a function or an action, and/or to cause a function or action.

As used herein, the term “module,” “software module,” “tool,” or “software tool” may generally refer to a piece of computer code, comprising instructions executable by a computer or related device, that may be independently loadable from long-term storage media (such as, but not limited to, a disk drive, CD-ROM, tape, or the like). “Module,” “software module,” “tool” or “software tool” may generally refer to subroutines, processes, Dynamic Link Libraries (DLLs), or the like. The term “module” may also refer generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation.

As used herein, the term “social network,” “contact network,” “community,” or formatives thereof may refer generally to a set of direct and/or indirect personal relationships. Direct personal relationships may generally include, for example, relationships with family members, friends, colleagues, coworkers and other people with which a user or group of users has had some form of direct contact, such as contact in person, by telephone, by email, by instant message, by letter, or the like. Indirect personal relationships may generally comprise, for example, relationships through first-degree relationships to additional users with whom a first user has not had some form of direct contact. For example, a friend of a friend represents an indirect personal relationship. In accordance with one or more embodiments of the present invention, a “social network,” “contact network,” “community,” or formatives thereof may comprise a group of individuals or groups of individuals for which a user possesses contact information. Contact information may generally comprise, for example, an e-mail address, website address, telephone number, mailing address, fax number, or any means of communication that may reach the individual or group of individuals.

As used herein, the term “member,” “registered member” or “registered user” may generally refer to any user that created a user account within the scope of any embodiment of the present invention. A “member” may be, for example, a person who accesses a website and creates a user account by submitting data or completing any fillable data field. In accordance with one or more embodiments of the present invention, the entered data may comprise a name, contact information, a title, a business name, a school affiliation, an alumni affiliation, a geocentric affiliation, a hobby listing, any other piece of data, or the like.

As used herein, the term “non-member,” “unregistered member” or “unregistered user” may generally refer to any individual, company, or business that has not created a profile or account with a website, social network, business network, blog, or the like.

As used herein, the terms “connection” and “contact,” may generally refer to any user to whom a first user or member has formed an association, or relationship via a website or any other electronic means. Connections may be added explicitly by a user, for example, the user selecting a particular other user to be a contact, or automatically created by a social networking site or any other electronic means based on common characteristics of the users (e.g., users who are alumni of the same educational institution). Connections in embodiments of the present invention may generally be bidirectional, but need not be, so the terms “connection” and “contact” depend on the frame of reference. For example, if Bob and Joe are both users and connected to each other in the website, Bob and Joe, both users, are also each other's contacts. The connection between users may be a direct connection; however, one or more embodiments of the present invention allow the connection to be indirect via one or more levels or degrees of connections. Also, the term “contact” need not require that users actually be contacts in accordance with the ordinary definition, it simply implies a connection utilizing embodiments of the present invention.

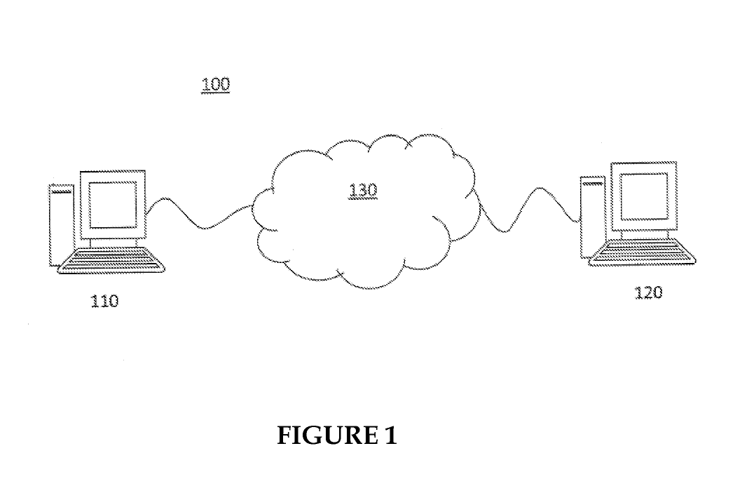

FIG. 1 depicts an exemplary system in accordance with an embodiment of the present invention. A basic system 100 comprises at least a transmitter 110, a receiver 120, and a transmission system 130 over which to transmit data. The transmission system 130 may be a partial or full deployment of most communication or computer networks or links, including any of, any multiple of, any combination of or any combination of multiples of an electronic circuit trace, transmission system electronic or optical physical medium, public or private, terrestrial wireless or satellite system, and wireline networks or links.

The network 130 may include, for example, network elements from a Public Switch Telephone Network (PSTN), the Internet, core and proprietary public networks, wireless voice and packet-data networks, such as 1G, 2G, 2.5G, 3G, 4G and 4G LTE Advanced telecommunication networks, wireless office telephone systems (WOTS) and/or wireless local area networks (WLANs), including, Bluetooth and/or IEEE 802.11 WLANs, wireless personal area networks (WPANs), wireless metropolitan area networks (WMANs) or the like; and/or communication links, such as Universal Serial Bus (“USB”) links; parallel port links, Firewire links, RS-232 links, RS-485 links, Controller-Area Network (“CAN”) links, or the like.

The network elements and/or communication links may include circuit-switched as well as packet-data elements to provide transport of content, triggers and/or other information; and may be configured to communicate such information using any number of protocols and in any manner consistent with exchanging such information among transmitter 110 and receiver 120. These protocols may include standardized, proprietary, open-source, and freely-available communication protocols for communicating content in circuit-switching and/or packet data networks, or the like.

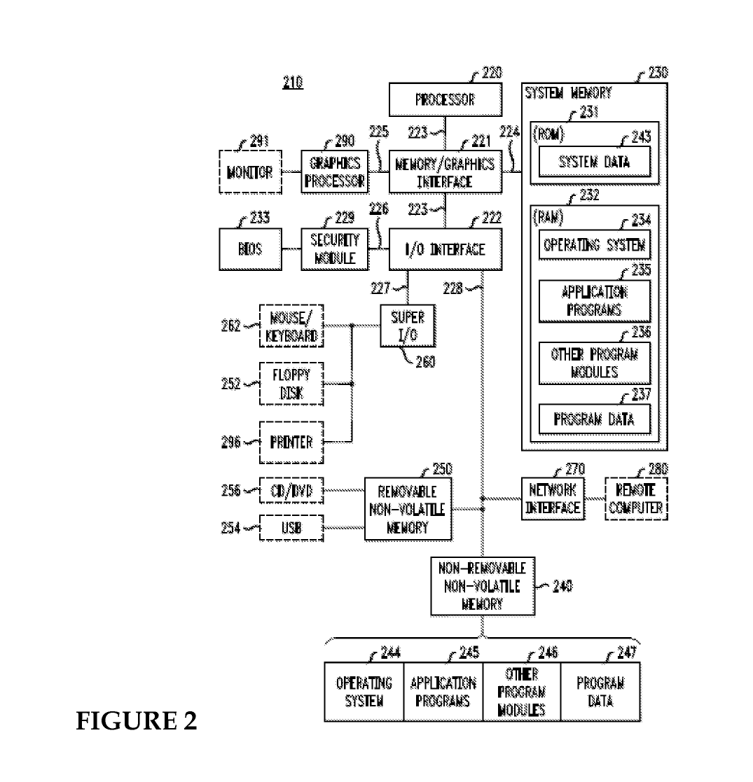

The transmitter 110 and receiver 120 may respectively comprise any communication device suitable for embodiments of the present invention. In an embodiment of the present invention, at least one of the transmitter 110 or receiver 120 may comprise at least a general purpose computer system, for example, as shown in FIG. 2. In an alternative embodiment of the present invention, transmitter 110 or receiver 120 may be any mobile device including, but not limited to, an Apple iPhone, a Blackberry device, an Android device, Personal Data Assistant (PDA), or the like.

It is contemplated within the embodiments of the present invention that any embodiment of the present invention may be implemented via the transmitter 110, the receiver 120, the network 130, or the like.

With reference to FIG. 2, a general purpose computing system in the form of a computer 210 is shown. As appreciated by embodiments for the present invention, more practical devices, such as mobile devices, mobile telephones, or the like, may be utilized than a general computer 210 for embodiments of the present invention. However, it is also appreciated there is a significant similarity in core components between a mobile device and a general computer 210. The following components are described for exemplary purposes only, and each component's mobile equivalent is also contemplated within embodiments of the present invention.

Optional components shown in dashed outline are not necessarily part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identifying and manufacturing information. In one or more embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237. It is contemplated within embodiments of the present invention that any embodiment of the present invention may be implemented via an application program 235 or other program modules 246 and may utilize program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up.

In one or more embodiments, a security module 229 may be incorporated to manage metering, billing, and enforcement of policies. The security module 229 may comprise any known security technology suitable for embodiments disclosed herein.

A super input/output chip 260 may be used to connect to a number of “legacy” peripherals, such as floppy disk 252, keyboard/mouse 262, and printer 296, as examples. The super I/O chip 260 may be connected to the I/O interface 222 with a low pin count (LPC) bus, in one or more embodiments. The super I/O chip 260 is widely available in the commercial marketplace.

In an embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In one or more embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet.

In one or more embodiments, the network interface may use a modem (not depicted) when a broadband connection is not available or is not used. It will be appreciated that the network connection shown is exemplary and other wired or wireless communications links between the computers may be used.

Although the computer 210 of FIG. 2 is described as an exemplary computing device for various applications of embodiments of the present invention, it should be appreciated, a multitude of similar computing devices exist and are equally suitable for embodiments of the present invention. It is further understood by embodiments of the present invention, a computing device may comprise all of the elements disclosed in FIG. 2, or any combination of one or more of such elements, in order to perform the necessary functions of the embodiments of the present invention.

It is understood by embodiments of the present invention that a computer, such as the one depicted in FIG. 2, may be connected to a computer network or system. A computer network includes the Internet, a global computer network, an internal computer network, dedicated server networks, and the like.

It is appreciated by embodiments of the present invention, in FIG. 1, that both transmitter 110 and receiver 120, may utilize certain of the features of the general computer 210 of FIG. 2, whereas many of such features or elements are incorporated in most communication devices presently in existence.

The system 100 of FIG. 1 may be utilized to implement the systems and methods for the transmission and reception of content disclosed herein. It should be noted, however, any transmission system, capable of transmitting bytes of data from a first device to a second device, over any physical medium, may be utilized in accordance with embodiments of the present invention. It is contemplated within embodiments of the present invention that any embodiment of the present invention or combination of embodiments may be implemented in a computer 210.

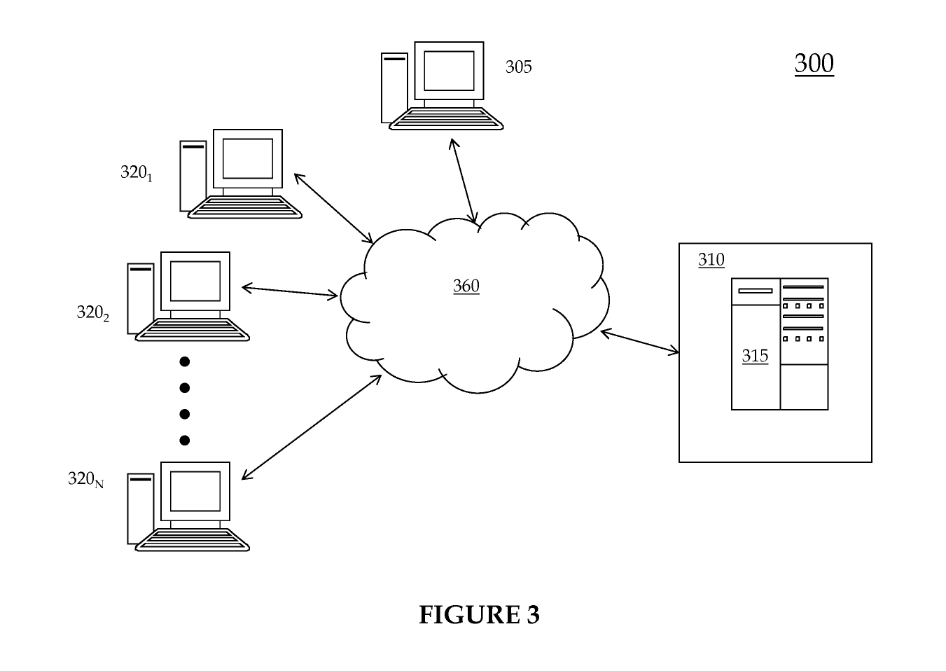

FIG. 3 depicts a basic system-level diagram of a system for transmitting and receiving content in accordance with an embodiment of the present invention. The system 300 generally comprises at least a first user 305 and secondary users 3201 and 3202, each in communication with an administrator 310, generally hosting a central server 315, through a network 360. A content submission or transfer in accordance with one or more embodiments of the present invention takes place over the network 360, which may comprise a global computer network, for example, the Internet.

Although FIG. 3 explicitly depicts three secondary users (labeled 3201, 3202, and 320N), it should be appreciated that N represents any number of users feasible in accordance with embodiments of the present invention. For ease of reference, as used herein, each of the terms “second user” or “secondary user” may refer to any one or all of the users 3201, 3202, and 320N within the system 300. Likewise, although FIG. 3 explicitly depicts only one first user 305, there may be more than one first user 305 in accordance with one or more embodiments of the present invention. That is, in certain embodiments, multiple users may perform the same or similar functions as the first user 305. In embodiments of the present invention, a first user or a second user may include any person, business or entity, capable of participating in the system and methods disclosed herein. In accordance with several embodiments of the present invention, a first user or a second user may be a consultant, an agency, or a corporate professional.

In accordance with an embodiment of the present invention, the first user 305 submits a content submission associated with a business practice. In one or more embodiments of the present invention, the content submission may relate to any topic on a best business practice. For example, the content submission may relate to any services of a consultant including, but not limited to, legal services, investment banking services, tax services, product design and development services, or the like. As an example, a law firm can submit content regarding the firm's practice areas as well as the contacts or attorneys in each department. It shall be understood that these exemplary embodiments should not be limiting with regards to the present invention and that the consultant may provide a content submission regarding any industry or field.

In an alternative embodiment of the present invention, the content submission may relate to any topic for a discussion forum or blog. For example, the first user 305 may submit content to system 300 relating to new technologies, insights, ideas, trends, news and best practices in a particular industry. In one or more embodiments of the present invention, the first user may use any number of engagement tools to submit content including, but not limited to, a Best Practice Point of View (“POV”), a presentation, a white paper, an article, a blog, a question, a request for proposal, an announcement, an event, a webinar, a learning opportunity, or a growth opportunity. A learning opportunity may include, but is not limited to, any educational experience using a tutorial, webinar, lecture, article, book, or the like. A growth opportunity may include, but is not limited to, any opportunity that will drive innovation, sales or improvement of an individual, company, business, trade organization, think tank, affinity group organization, non-profit, governmental unit, or the like.

In accordance with one or more embodiments of the present invention, a Best Practice Point of View generally refers to any blog-like submission containing a perspective on a best practice in a particular industry, political sector, economic field, technology, recreational or social policy area, and the like. For example, a consultant or agency may submit a POV using system 300 to discuss a particular development in the law or a particular trend in a product design phase. It shall be appreciated that any number of secondary users or first users may comment or reply on the POV while using system 300.

In an embodiment of the present invention, the content submission may include a wide variety of data including, but not limited to, binary data, structured data (such as data stored in databases), unstructured data (such as image documents), folders, text, video, audio, word processing documents, source code files, object code files, physical documents, physical objects, tags, or combinations thereof.

In yet another embodiment of the present invention, the content submission may refer to a webinar, webinar location, pre-recorded webinar, or the like. In yet another embodiment of the present invention, the first user can register a second user for the webinar, pre-recorded webinar, or the like, using system 300.

In accordance with an embodiment of the present invention, the second user may be a registered member of any social network, business network, blog, website, or the like. In an alternative embodiment of the present invention, the second user may be an unregistered member of the social network, business network, blog, website, or the like. This allows system 300 to provide a more productive and flexible system that allows a first user to submit content to a second user, regardless of whether the second user is a registered member or an unregistered member of a network, blog, website, or the like.

In a basic exemplary embodiment, within the system 300, a first user 305 may be capable of transmitting data related to the content submission to the administrator 310, using a mobile device. The mobile device in the context of this application may include, but is not limited to, an Apple iPhone, iPad, a Blackberry device, an Android device, mobile e-tablets, Personal Data Assistants (PDA) or the like, or may generally include a general purpose computer, as discussed below.

As explained above, the network 360 may comprise any network suitable for embodiments of the present invention. For example, the network 360 may be a partial or full deployment of most any communication/computer network or link, including any of, any multiple of, any combination of or any combination of multiples of a public or private, terrestrial wireless or satellite, and wireline networks or links. The network 150 may include, for example, network elements from a Public Switch Telephone Network (PSTN), the Internet, core and proprietary public networks, wireless voice and packet-data networks, such as 1G, 2G, 2.5G, 3G, 4G and 4G LTE Advanced telecommunication networks, wireless office telephone systems (WOTS), Global Systems for Mobile communications (GSM), General Packet Radio Service (GPRS) systems, Enhanced Data GSM Environments (EDGE), and/or wireless local area networks (WLANs), including, Bluetooth and/or IEEE 802.11 WLANs, wireless personal area networks (WPANs), wireless metropolitan area networks (WMANs) and the like; and/or communication links, such as Universal Serial Bus (USB) links; parallel port links, Firewire links, RS-232 links, RS-485 links, Controller-Area Network (CAN) links, and the like.

In accordance with an embodiment of the present invention, any of the administrator or users may comprise a general purpose computer, for example, as shown in the form of a computer 210 depicted in FIG. 2. As appreciated by embodiments for the present invention, more practical devices, such as mobile devices, mobile telephones, or the like, are likely to be utilized than a general computer 210 for embodiments of the present invention. However, it is also appreciated there is a significant similarity in core components between a mobile device and a general computer 210. The following components are described for exemplary purposes only, and each component's mobile equivalent is also contemplated within embodiments of the present invention.

System 300 of FIG. 3 may be utilized to implement the systems and methods for the transmission and reception of content disclosed herein. It should be noted, however, any transmission system, capable of transmitting bytes of data from a first device to a second device, over any physical medium, may be utilized in accordance with embodiments of the present invention.

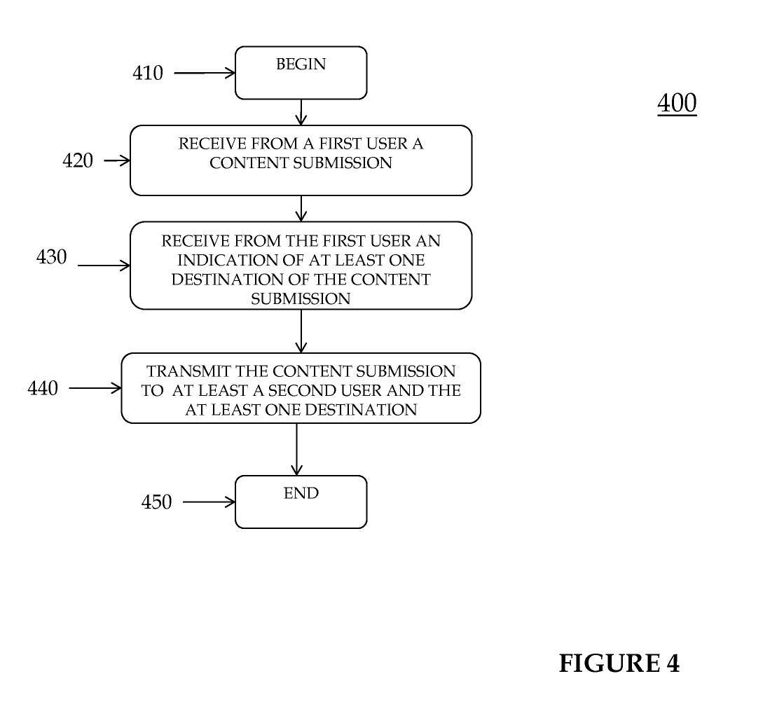

FIG. 4 depicts a flowchart of a method for the transmission and reception of content implemented in a central server in accordance with an embodiment of the present invention. For convenience, the method 400 is described with reference to system 300 of FIG. 3. The method 400 may be carried out with system 100 of FIG. 1 or within other system architectures as well.

The method 400 begins at step 410. At step 420, administrator 310 receives a content submission from a first user 305. In accordance with an embodiment of the present invention, a content submission may relate to any topic associated with a best business practice. In an embodiment of the present invention, the content submission may relate to any services of a consultant including, but not limited to, legal services, investment banking services, tax services, product design and development services, or the like. For example, a law firm can submit content regarding the firm's practice areas as well as the contacts or attorneys in each department. It shall be understood that these exemplary embodiments should not be limiting with regards to the present invention and that the consultant may provide a content submission regarding any industry or field.

In an alternative embodiment of the present invention, the content submission may relate to any topic for a discussion forum or blog. For example, first user 305 may submit content to system 300 relating to new technologies, insights, ideas, trends, news and best practices in a particular industry. In one or more embodiments of the present invention, the first user may use any number of engagement tools to submit content including, but not limited to, a Best Practice Point of View, a presentation, a white paper, an article, a blog, a question, a request for proposal, an announcement, an event, a webinar, a learning opportunity, or a growth opportunity. A learning opportunity may include, but is not limited to, any educational experience using a tutorial, webinar, lecture, article, book, or the like. A growth opportunity may include, but is not limited to, any opportunity that will drive innovation, sales or improvement of an individual, company, business, trade organization, think tank, affinity group organization, non-profit, governmental unit, or the like.

In an embodiment of the present invention, the content submission may include a wide variety of data including, but not limited to, binary data, structured data (such as data stored in databases), unstructured data (such as image documents), folders, text, video, audio, word processing documents, source code files, object code files, physical documents, physical objects, tags, or combinations thereof.

At step 430, administrator 310 receives an indication of at least one destination of the content submission from first user 305. In accordance with one or more embodiments of the present invention, the destination may comprise at least one of a business, organization, affinity group, contact, a group of businesses, a group of organizations, a group of affinity groups, a group of contacts, a registered company, a group of registered companies, a best practice group, a product group, a service group, a regional group, a community, a business website, an organization website, a group website, a social networking website, a group of social networking websites, a blog, a news feed, any fillable data field, any combination of fillable data fields, any device configured to receive data, any computer system configured to receive data, or the like.

In accordance with an embodiment of the present invention, the at least one destination may be associated with an internal network contact or an external network contact. An internal network contact may be part of one or more networks that first user 305 created, joined or registered for. Examples of internal networks may include, but is not limited to, the user's contact networks, open innovation networks, associates networks, interactive marketing networks, leaders networks, or the like. In contrast, an external network contact is not a part of the user's networks, but may be part of one or more networks in which first user 305 did not join or register for.

In yet an alternative embodiment of the present invention, the at least one destination may be associated with one or more user communities. For example, communities associated with the at least one destination may include, but are not limited to, an open network community, a premium network community, a sponsored community or a private community. In an embodiment of the present invention, an open network community may allow any user registered to a social networking website or business networking site to join. For example, users of the open network may discuss content submissions focused on any business practice in any geographic region, i.e., users may discuss innovative ideas and trends relating to products or services in a specific country. In accordance with another embodiment of the present invention, a premium network community may be limited to certain registered users of a social networking or business networking website, i.e., users who pay a fee. In accordance with an embodiment of the present invention, a sponsored community may be created and owned by a member for a fee and may allow any user registered to a social networking website or business networking site to join. In accordance with an embodiment of the present invention, a sponsored community may be limited to certain registered users possessing certain characteristics, i.e., current or potential customers or users who are part of the same organization, employer, etc. In accordance with an embodiment of the present invention, a user of a sponsored community may create an agenda and list, invite or approve contacts/users who may join the community. In accordance with an embodiment of the present invention, a private community may not be visible to the general membership and other users and is limited to certain registered users of a social networking or business networking website possessing certain characteristics, i.e., current or potential customers or users who are part of the same organization, employer, etc. In an embodiment of the present invention, a user of a private community may create an agenda for the community, submit proprietary and other best practice content to the community and its members, and list, invite or approve contacts/users who may join the community.

At step 440, administrator 310 transmits first user 305's content submission to at least a second user 320 and the at least one destination. The content submission is transferred to at least second user 320 and the at least one destination via network 360 by using any of the data transmission techniques described in the present application and in accordance with embodiments of system 300.

In an embodiment of the present invention, second user 320 may be a consultant, an agency, academic, scientist, corporate professional, other professional or affinity group member. In an embodiment of the present invention, second user 320 may be registered or unregistered with a website, social network, business network, blog, or the like. In yet another embodiment of the present invention, second user 320 may be an internal network contact or an external network contact. The method 400 is concluded at step 450.

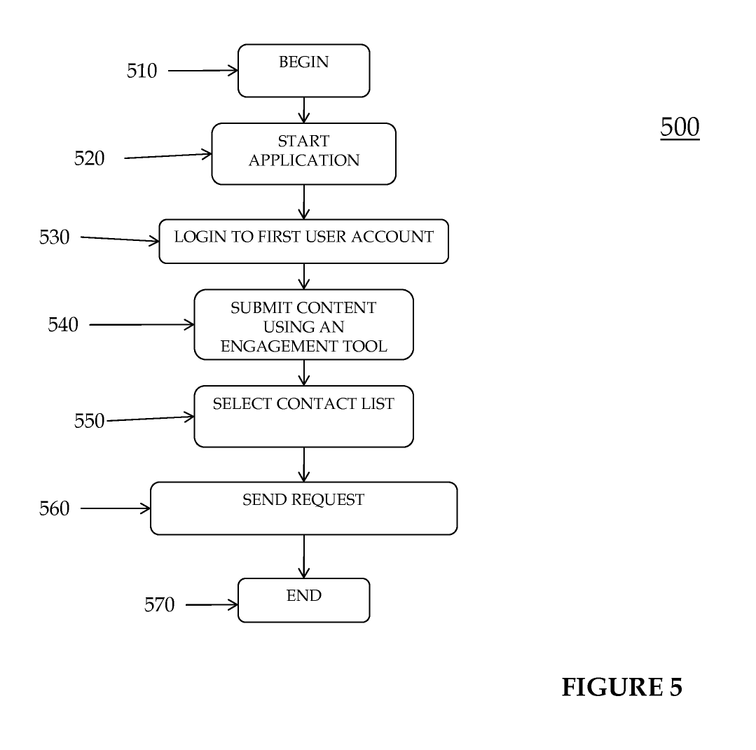

FIG. 5 depicts a flowchart of a method for the transmission and reception of content from the perspective of a first user in accordance with the embodiments of the present invention. For convenience, the method 500 is described with reference to system 300 of FIG. 3. The method 500 may be carried out with system 100 of FIG. 1 or within other system architectures as well.

The method 500 begins at step 510. At step 520, a first user 305 enables a software application on a mobile device or personal computer. The software application generally comprises executable instructions to enable the first user to engage in the methods and systems disclosed herein, and may comprise any format, as discussed above.

At step 530, first user 305 logs into a user created account, generally stored within a database on the central server 315, hosted by the administrator 310. In an embodiment of the present invention, the first user 305 may be a consultant or an agency in any industry or field. At step 540, the first user 305 submits a content submission associated with a best practice by using an engagement tool.

In one or more embodiments of the present invention, the content submission may relate to any business, non-profit, government, social policy, affinity group or other best practice topic. In an embodiment of the present invention, the content submission may relate to any services of a consultant including, but not limited to, legal services, investment banking services, tax services, product design and development services, or the like. For example, a law firm can submit content regarding the firm's practice areas as well as the contacts or attorneys in each department. It shall be understood that these exemplary embodiments should not be limiting with regards to the present invention and that the consultant may provide a content submission regarding any industry or field.

In an alternative embodiment of the present invention, the content submission may relate to any topic for a discussion forum or blog. For example, the first user 305 may submit content to system 300 relating to new technologies, insights, ideas, trends, news and best practices in a particular industry. In one or more embodiments of the present invention, the first user may use any number of engagement tools to submit content including, but not limited to, a Best Practice Point of View, a presentation, a white paper, a report, an article, a blog, a question, a request for proposal, an announcement, an event, a webinar, a learning opportunity, an insight, an idea, a product concept, a trend or a growth opportunity. A learning opportunity may include, but is not limited to, any educational experience using a tutorial, webinar, lecture, article, book, or the like. A growth opportunity may include, but is not limited to, any opportunity that will drive innovation, sales or improvement of an individual, company, business, trade organization, think tank, affinity group organization, non-profit, governmental unit, or the like.

In accordance with embodiments of the present invention, a Best Practice Point of View generally refers to any blog-like submission containing a perspective on a best practice in a particular industry, political sector, economic field, technology, recreational or social policy area, and the like. For example, a consultant or agency may submit a POV using system 300 to discuss a particular development in the law or a particular trend in a product design phase. It shall be appreciated that any number of secondary users or first users may comment or reply on the POV while using system 300.

In an embodiment of the present invention, the content submission may include a wide variety of data including, but not limited to, binary data, structured data (such as data stored in databases), unstructured data (such as image documents), folders, text, video, audio, word processing documents, source code files, object code files, physical documents, physical objects, tags, or combinations thereof.

At step 550, first user 305 selects a contact list as a destination for the content submission. In accordance with an embodiment of the present invention, the contact list may include members from various networks and communities.

In accordance with an embodiment of the present invention, a member of the contact list may be an internal network contact or an external network contact. An internal network contact may be part of one or more networks that first user 305 joined or registered for. Examples of internal networks may include, but is not limited to, open innovation networks, associates networks, interactive marketing networks, leaders networks, or the like. In contrast, an external network contact may be part of one or more networks in which first user 305 did not join or register for.

In yet an alternative embodiment of the present invention, a member of the contact list may be associated with one or more user communities. For example, communities may include, but are not limited to, an open network community, a premium network community, a sponsored community or a private community. In an embodiment of the present invention, an open network community may allow any user registered to a social networking website or business networking site to join. As an example, users of the open network may discuss content submissions focused on any business practice in any geographic region, i.e., users may discuss innovative ideas and trends relating to products or services in a specific country. In accordance with another embodiment of the present invention, a premium network community may be limited to certain registered users of a social networking or business networking website, i.e., users who pay a fee. In accordance with an embodiment of the present invention, a sponsored community may be created and owned by a member for a fee and may allow any user registered to a social networking website or business networking site to join. In accordance with an embodiment of the present invention, a sponsored community may be limited to certain registered users possessing certain characteristics, i.e., current or potential customers or users who are part of the same organization, employer, etc. In accordance with an embodiment of the present invention, a user of a sponsored community may create an agenda and list, invite or approve contacts/users who may join the community. In accordance with an embodiment of the present invention, a private community may not be visible to the general membership and other users and is limited to certain registered users of a social networking or business networking website possessing certain characteristics, i.e., current or potential customers or users who are part of the same organization, employer, etc. In an embodiment of the present invention, a user of a private community may create an agenda for the community, submit proprietary and other best practice content to the community and its members, and list, invite or approve contacts/users who may join the community.

At step 560, the first user 305 sends the request containing a content submission and a selected contact list to administrator 310 via network 360. The method 500 is concluded at step 570.

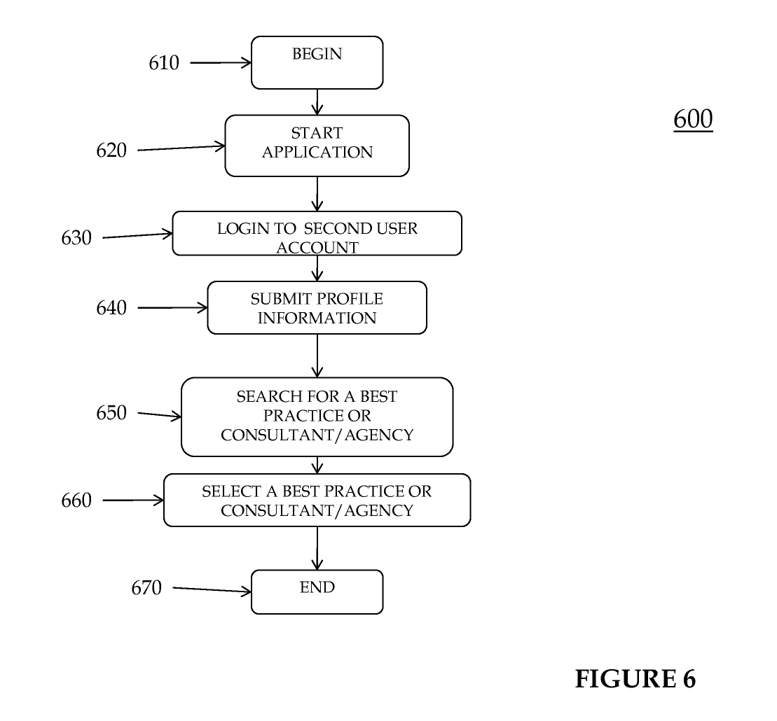

FIG. 6 depicts a flowchart of a method for the transmission and reception of content from the perspective of a second user in accordance with the embodiments of the present invention. For convenience, the method 600 is described with reference to system 300 of FIG. 3. The method 600 may be carried out with system 100 of FIG. 1 or within other system architectures as well.

The method 600 begins at step 610. At step 620, a second user 320 enables a software application on a mobile device or personal computer. The software application generally comprises executable instructions to enable the first user to engage in the methods and systems disclosed herein, and may comprise any format, as discussed above.

At step 630, second user 320 logs into a user created account, generally stored within a database on the central server 315, hosted by the administrator 310. In an embodiment of the present invention, second user 320 may be a corporate professional in any industry or field. At step 640, second user 320 submits profile information. In an embodiment of the present invention, profile information may include, but is not limited to, the second user's contact information, educational background, work history, technical expertise, skills and views on a best practice.

At step 650, second user 320 searches for a best business practice using system 300. In accordance with one or more embodiments of the present invention, the searching may be conducted based on any number of parameters submitted by the second user and any searching algorithm used by central server 315. In an embodiment of the present invention, second user 320 may search for a best practice or a consultant or an agency that fits the user's needs. For example, an inventor may be interested in a law firm that will help him to prepare a patent application for his invention. The inventor can use system 300 to search for law firms that specialize in intellectual property law, and specifically in the preparation and prosecution of patent applications.

At step 660, second user 320 selects a best practice or consultant or agency that fits the user's needs. This selection is transmitted via network 360 to administrator 310. At step 670, the method 600 is concluded.

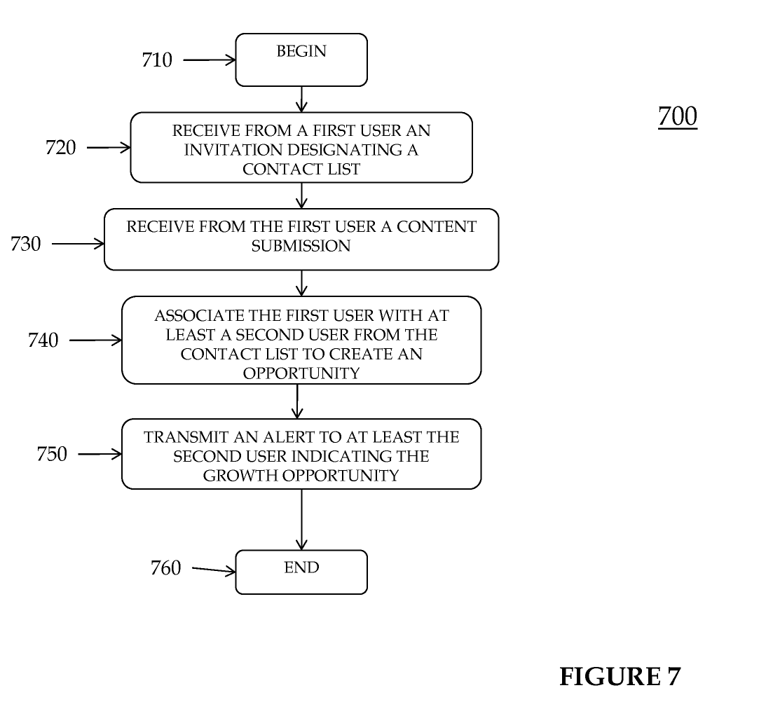

FIG. 7 depicts a flowchart of a method for the transmission and reception of content from the perspective of an administrator in accordance with the embodiments of the present invention. For convenience, the method 700 is described with reference to system 300 of FIG. 3. The method 700 may be carried out with system 100 of FIG. 1 or within other system architectures as well.

The method 700 begins at step 710. At step 720, administrator 310 receives an invitation designating a contact list from first user 305. The invitation may designate a contact list that includes members from various networks and communities.

In accordance with an embodiment of the present invention, a member of the contact list may be an internal network contact or an external network contact. An internal network contact may be part of one or more networks that first user 305 joined or registered for. Examples of internal networks may include, but is not limited to, open innovation networks, associates networks, interactive marketing networks, leaders networks, or the like. In contrast, an external network contact may be part of one or more networks in which first user 305 did not join or register for.

In yet an alternative embodiment of the present invention, a member of the contact list may be associated with one or more user communities. For example, communities may include, but are not limited to, an open network community, a premium network community, a sponsored community or a private community. In an embodiment of the present invention, an open network community may allow any user registered to a social networking website or business networking site to join. For example, users of the open network may discuss content submissions focused on any business practice in any geographic region, i.e., users may discuss innovative ideas and trends relating to products or services in a specific country. In accordance with another embodiment of the present invention, a premium network community may be limited to certain registered users of a social networking or business networking website, i.e., users who pay a fee. In accordance with an embodiment of the present invention, a sponsored community may be created and owned by a member for a fee and may allow any user registered to a social networking website or business networking site to join. In accordance with an embodiment of the present invention, a sponsored community may be limited to certain registered users possessing certain characteristics, i.e., current or potential customers or users who are part of the same organization, employer, etc. In accordance with an embodiment of the present invention, a user of a sponsored community may create an agenda and list, invite or approve contacts/users who may join the community. In accordance with an embodiment of the present invention, a private community may not be visible to the general membership and other users and is limited to certain registered users of a social networking or business networking website possessing certain characteristics, i.e., current or potential customers or users who are part of the same organization, employer, etc. In an embodiment of the present invention, a user of a private community may create an agenda for the community, submit proprietary and other best practice content to the community and its members, and list, invite or approve contacts/users who may join the community.

At step 730, administrator 310 receives a content submission from a first user 305. In accordance with an embodiment of the present invention, a content submission may relate to any topic associated with a best business practice. In an embodiment of the present invention, the content submission may relate to any services of a consultant including, but not limited to, legal services, investment banking services, tax services, product design and development services, or the like. For example, a law firm can submit content regarding the firm's practice areas as well as the contacts or attorneys in each department. It shall be understood that these exemplary embodiments should not be limiting with regards to the present invention and that the consultant may provide a content submission regarding any industry or field.

In an alternative embodiment of the present invention, the content submission may relate to any topic for a discussion forum or blog. For example, first user 305 may submit content to system 300 relating to new technologies, insights, ideas, trends, news and best practices in a particular industry. In one or more embodiments of the present invention, the first user may use any number of engagement tools to submit content including, but not limited to, a Best Practice Point of View, a presentation, a white paper, an article, a blog, a question, a request for proposal, an announcement, an event, a webinar, a learning opportunity, or a growth opportunity. A learning opportunity may include, but is not limited to, any educational experience using a tutorial, webinar, lecture, article, book, or the like. A growth opportunity may include, but is not limited to, any opportunity that will drive innovation, sales or improvement of an individual, company, business, trade organization, think tank, affinity group organization, non-profit, governmental unit, or the like.

In an embodiment of the present invention, the content submission may include a wide variety of data including, but not limited to, binary data, structured data (such as data stored in databases), unstructured data (such as image documents), folders, text, video, audio, word processing documents, source code files, object code files, physical documents, physical objects, tags, or combinations thereof.

At step 740, administrator 310 associates first user 305 with at least a second user 320 from the contact list in order to create an opportunity. In an embodiment of the present invention, the associating step may be completed by any matching or associating algorithm located at central server 315. For example, a first user may be matched with a second user based on the first user selecting a second user from the contact list. Alternatively, the first user may be matched with a second user from the contact list using an algorithm based on matching keywords, networks, communities, or the like.

In an embodiment of the present invention, the opportunity may be a learning opportunity or a growth opportunity. A learning opportunity may include, but is not limited to, any educational experience using a tutorial, webinar, lecture, article, book, or the like. A growth opportunity may include, but is not limited to, any opportunity that will drive innovation, sales or improvement of an individual, company, business, trade organization, think tank, affinity group organization, non-profit, governmental unit, or the like. In perspective, a first user may use a content submission consistent with embodiments of the present invention to seek any opportunity including, but not limited to, job opportunities or additional clients for the user's business.

At step 750, administrator 310 transmits an alert discussing the opportunity to at least second user 320's personal computer or mobile device via network 360. The alert may be one of various forms including, but not limited to, an email message, SMS type notification, or pre-recorded telephone call. At step 760, method 700 is concluded.

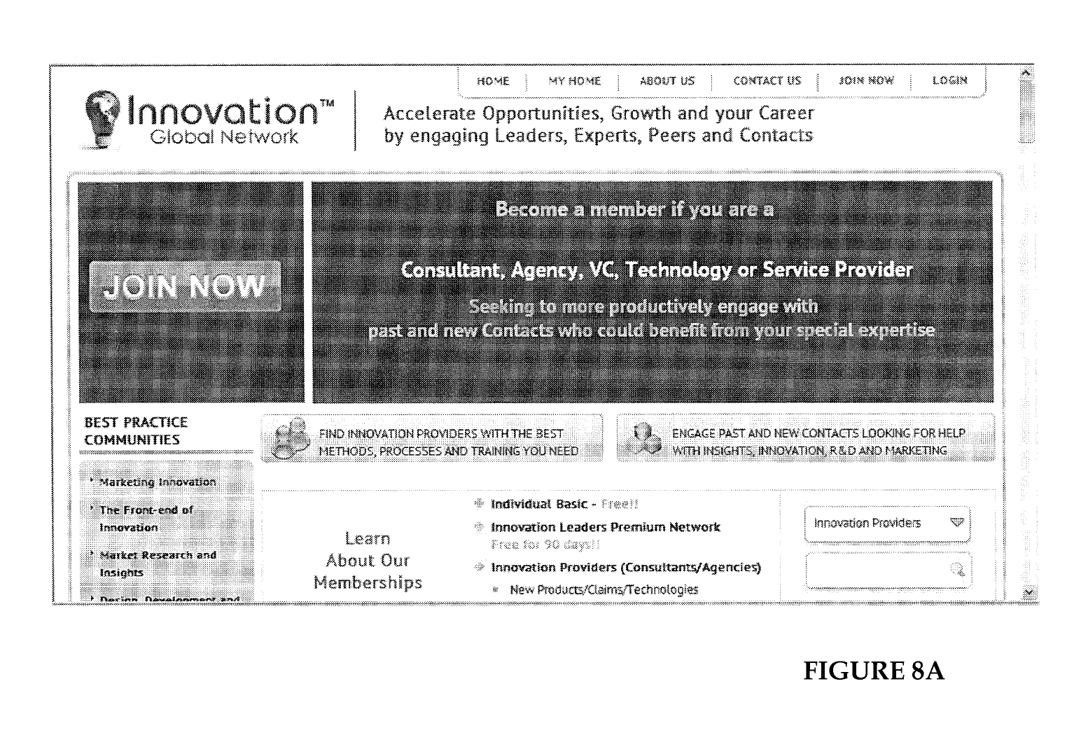

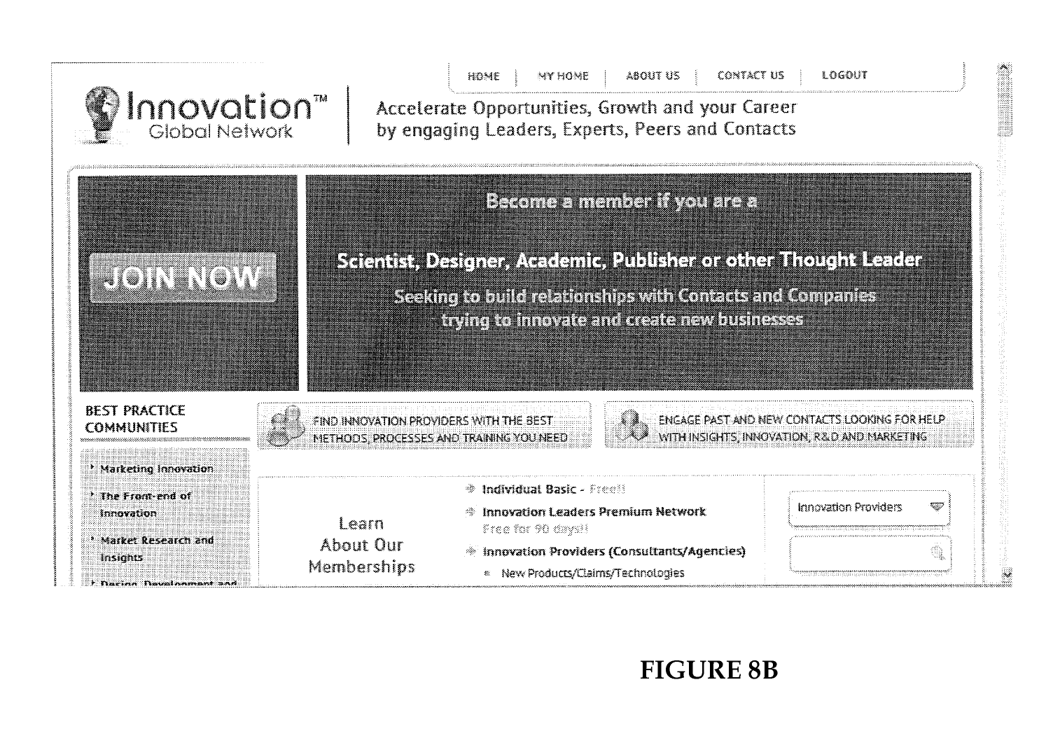

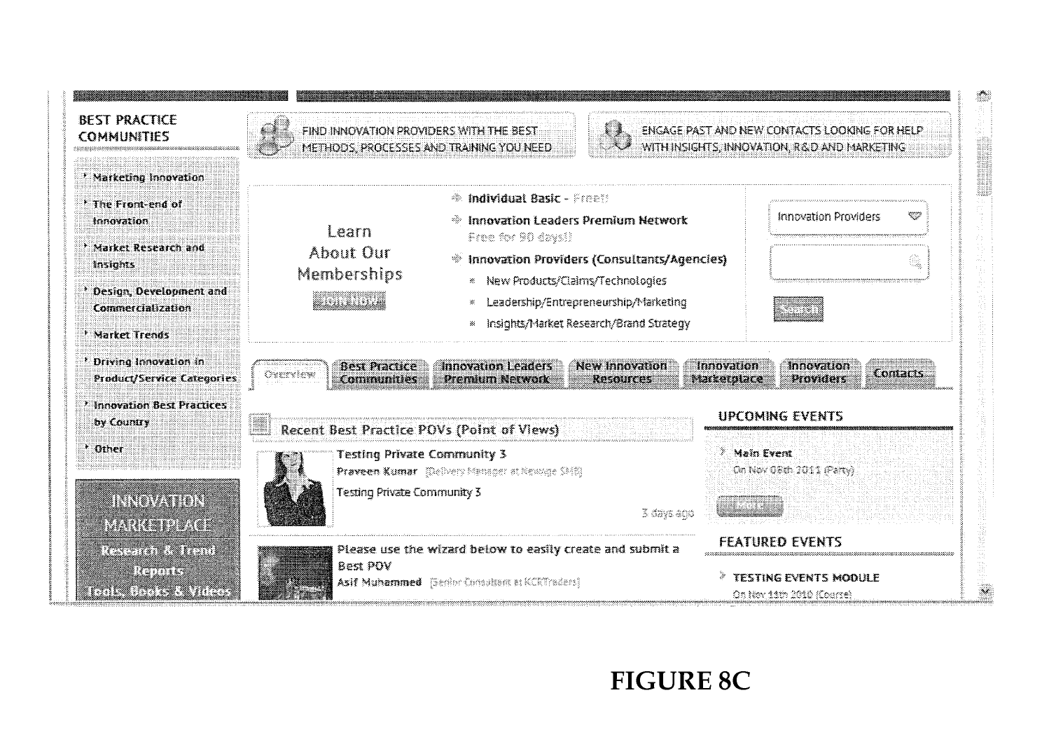

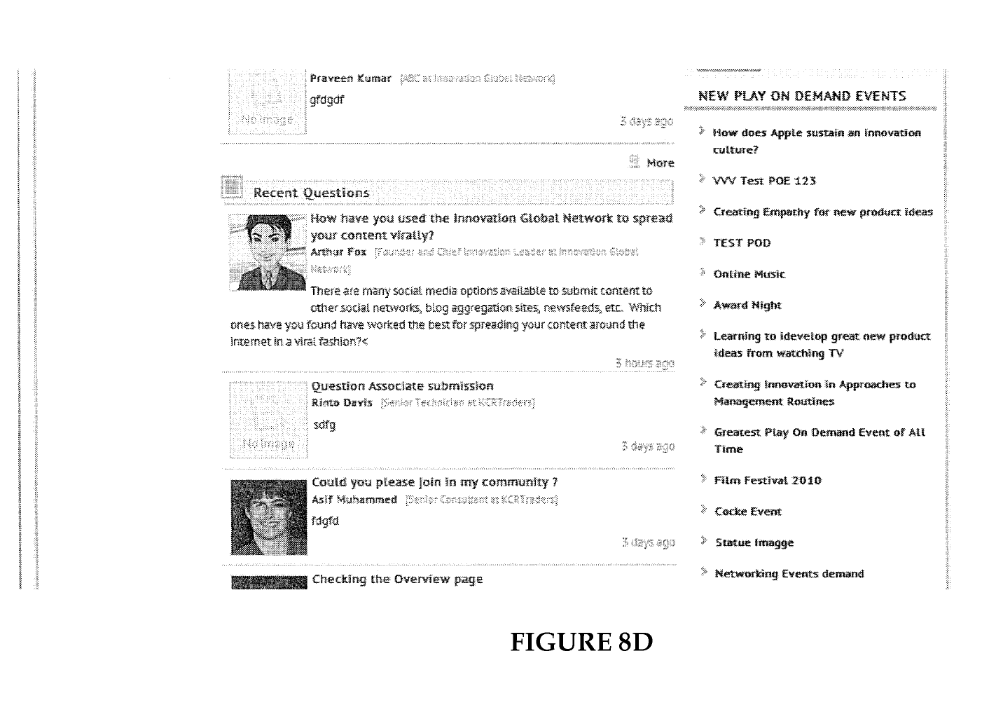

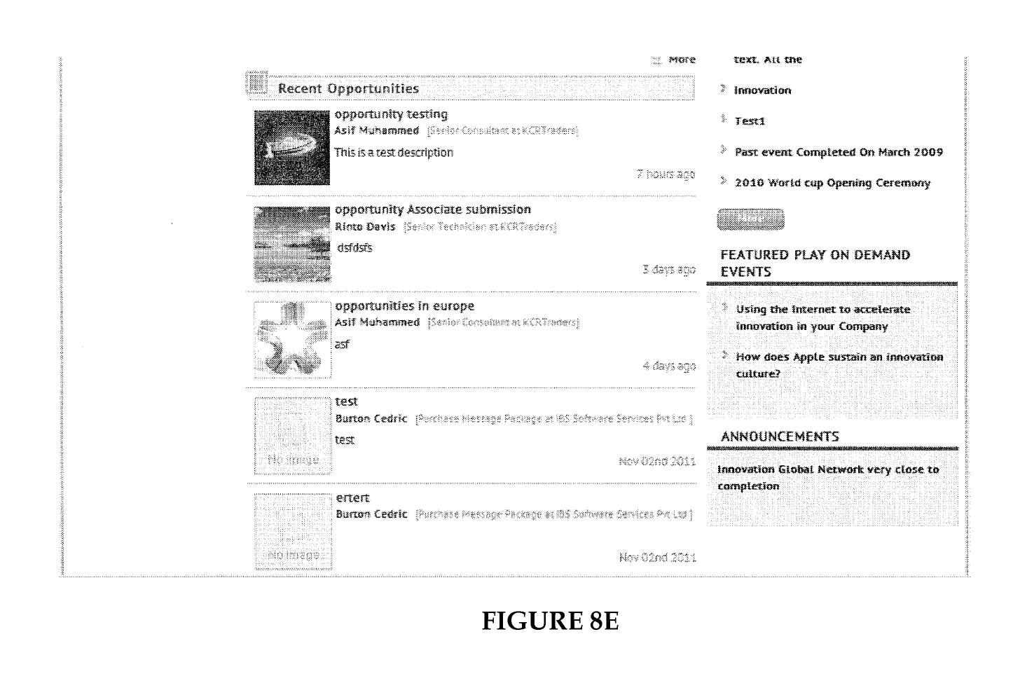

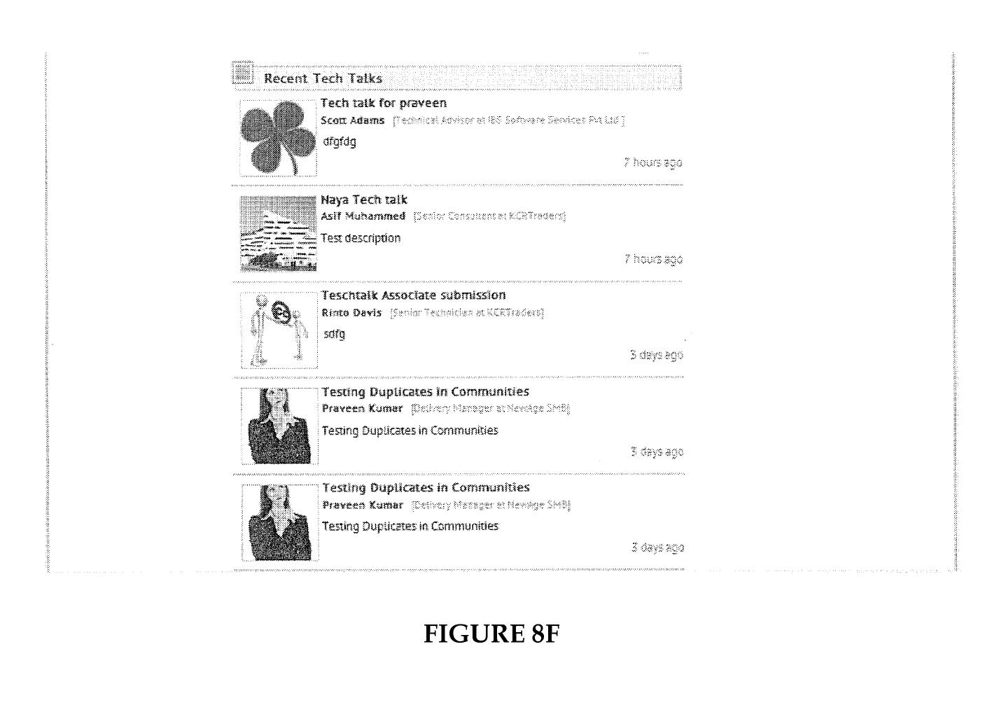

FIGS. 8-11 depict various exemplary systems and methods for the transmission and reception of content in accordance with embodiments of the present invention. In accordance with one or more embodiments of the present invention, a system and method are provided for allowing users to create, disseminate, access content and interact regarding industry best practices enhancing capabilities to generate innovation pipelines, sales and growth. In accordance with one or more embodiments of the present invention, a system and method for the transmission and reception of content may generally comprise: a module for mass colleague and contact importation; an engagement tool set; and a content submission process configured to enable companies, organizations, affinity groups individuals, or the like to expand an ability to create, disseminate, access and interact on industry best practices enhancing capabilities to generate innovation pipelines, sales and growth. In accordance with one or more embodiments of the present invention, a system and method is provided to greatly expand a user's ability to create, disseminate, access and interact with current and high potential new contacts on industry best practices and other content enhancing their capabilities to achieve a wide variety of objectives such as generating innovation pipelines and generating sales leads.

In accordance with one or more embodiments of the present invention, a system and method for the transmission and reception of content may generally be configured for enabling companies and individuals to greatly expand their ability to create, disseminate, access and interact on industry best practices enhancing their capabilities to generate innovation pipelines, sales and growth.

In accordance with one or more embodiments of the present invention, members or users of the system may add value to the system and method discussed herein, for example by bringing in new high potential contacts and by creating content and learning opportunities. In accordance with one or more embodiments of the present invention, learning opportunities may comprise, for example, workshops, panel discussions, webinars, or the like. One advantage of these features of one or more embodiments of the present invention may be that the system and method for the transmission and reception of content submission may be valuable to existing companies, organizations, affinity groups, individual members, users, or the like, and may be attractive to new participants.

In accordance with one or more embodiments of the present invention, a system and method for the transmission and reception of content is provided for creating value circles among businesses, organizations, and affinity group members resulting in exponential growth in new client opportunities and substantially increasing business and other opportunities among existing contacts. In accordance with one or more embodiments of the present invention, a system and method for the transmission and reception of content may comprise: providing members with a means to actively recruit and engage business colleagues, contacts and other users around content submissions of best industry practices and other content.

In accordance with one or more embodiments of the present invention, a system and method for the transmission and reception of content may comprise: receiving a content submission from a user; receiving an indication of at least one destination of the content submission from the user, wherein at least one destination may include a business, organization, affinity group, contact, a group of business, a group of organizations, a group of affinity groups, contacts, a registered company, a group of registered companies, a best practice group, a best practice community, a product group, a product community, a service group, a service community, a regional group, a regional community, a geocentric group, a geocentric community, a business website, an organization website, an affinity group website, a social networking website, a blog, a news feed, any other fillable data field, any combination of fillable data fields, any device configured for reception of information, or the like; transmitting the content submission to at least one destination.

In accordance with one or more embodiments of the present invention, a content submission may generally comprise, for example, a Point of View on best practices and other content, an event announcement, a whitepaper, a presentation, an article, video, audio, photo, or the like. In accordance with one or more embodiments of the present invention, the systems and methods for the transmission and reception of content disclosed herein may result in a virtuous circle wherein an expansion of new actively engaged network members are recruited creating a larger pool of opportunities for existing members participating in the network and valuable content creation is increased, which may motivate even more individuals to join thereby expanding the pool of opportunities further and creating even more valuable content.

In accordance with one or more embodiments of the present invention, a system and method for the transmission and reception of content may comprise a set of computer implemented instructions comprising allowing members to mass invite current business colleagues and contacts from their e-mail lists, contact managers and social networks to participate in the network and become part of a contact network. In accordance with one or more embodiments of the present invention, a system and method for the transmission and reception of content may comprise a set of computer implemented instructions comprising: creating and submitting a wide variety of content, wherein the content may comprise any content disclosed in any embodiment of the present invention, for example, presentations, white papers, articles, blogs, questions, requests for proposals, announcements, video files, audio files, photos, pre-recorded webinars, or the like. In accordance with one or more embodiments of the present invention, a system and method for the transmission and reception of content may comprise a set of computer implemented instructions comprising submitting content to both engage all current colleagues, contact clients, no matter if the individual is an internal network or external network contact, and engage and make many new high potential contacts or clients inside and outside the network.

In accordance with one or more embodiments of the present invention, a system and method for the transmission and reception of content is provided comprising a content submission module configured to enable members to submit content to all of their colleagues and contacts to review and comment on regardless of whether they have accepted their invitations to join a network. In accordance with one or more embodiments of the present invention, the system and method for the transmission and reception of content may comprise a software module, wherein the software module may keep track of individuals who have not accepted an invitation to join and uniquely enables members to still submit links to the content to them with invitations to review and comment on it. In accordance with one or more embodiments of the present invention, a system and method for the transmission and reception of content may comprise a module configured to allow a member to engage all of the member's current colleagues and contacts regardless of whether they have joined a network. One advantage of the embodiments of the invention disclosed herein is allowing almost all company or organization representatives and independent consultants or agents to regularly engage, for example, more than 2.5-25% of what may be hundreds to thousands of contacts on various lists. It is contemplated within the embodiments of the present invention that any percentage of contacts may be regularly engaged utilizing the systems and methods disclosed herein. As used herein, the term “regularly,” may generally comprise any unit of time or time period, for example, daily, weekly, bi-weekly, monthly, yearly, or the like.

In accordance with one or more embodiments of the present invention, a system and method for the transmission of content for engaging new high potential contacts or clients, comprising a module configured to display content in a plurality of communities, wherein each of the plurality of communities is focused on a topic, category, region, or the like relevant to the content. In accordance with one or more embodiments of the present invention, each of the plurality of communities may comprise community participants. In accordance with one or more embodiments of the present invention, a system and method for the transmission and reception of content may comprise an e-mail alert module configured to alert community participants of the addition of content. In accordance with one or more embodiments of the present invention, the e-mail alert module or alternatively, for example, a quality control module, may be configured to ensure content reaches members of a network, wherein the content is most relevant to the members of the network.

In accordance with one or more embodiments of the present invention, a system and method for the transmission and reception of content may comprise a business-oriented electronic communication, which may comprise a website, configured to enable innovation companies, corporate professionals, and others, to engage on innovation best practices and any other matter with the objective of developing formal relationships. In accordance with one or more embodiments of the present invention, innovation companies may comprise, for example, agencies, consultants, technology providers, or any other group of users. One advantage of embodiments of the present invention may be providing a focus exceeding the scope of just networking to foster engagement between a company or an individual and an entire business contact network, and potentially new contacts.

In accordance with one or more embodiments of the present invention, a system and method for the transmission and reception of content may comprise a display module configured to display content on profiles of an individual submitting the content and a company, organization, affinity group, or the like the individual belongs to. In accordance with one or more embodiments of the present invention, a system and method for the transmission and reception of content may comprise an alert module configured to alert members of the submission of content that may be relevant to the members by matching key words or phrases in the content with the members profiles and transmitting e-mail or any electronic message to the member, wherein the e-mail or electronic message may comprise, for example, a link to the content or any other means to access the content, wherein the alert module may also be configured to display the content on a targeted member's home page. As used herein, a “home page” may be the initial data entry point a user may access when first activating the system, or alternatively, the common definition of a “home page” in the Internet or computer science context.

In accordance with one or more embodiments of the present invention, a system and method for the transmission and reception of content may comprise content submission process module configured to enable a company or individual to create content and disseminate the content directly to an entire contact network, wherein the content may be disseminated to members of a network or non-members of the network. In accordance with one or more embodiments of the present invention, content may be submitted to individuals outside of a contact network or within the membership of the network. One benefit of embodiments of the present invention may be that members or content creators may achieve an increased impact and value from their intellectual property and content because content may be submitted to a broad range of recipients, both members and non-members of a network. In accordance with one or more embodiments of the present invention, a system and method for the transmission and reception of content may comprise a navigation bar configured to allow a user to follow the steps of submitting a Point of View (“POV”), a resource, and any other content. In accordance with one or more embodiments of the present invention, a POV may comprise any opinion or fact based information created by a user. In accordance with one or more embodiments of the present invention, the resource may comprise, for example, presentation, whitepaper, or the like. In accordance with one or more embodiments of the present invention, a system and method for the transmission and reception of content may comprise a central module for creating a single location configured to submit content to and engage with a user's or group's entire business contact network and beyond.

In accordance with an alternative embodiment of the present invention, a computer system is provided comprising a server computer and a database of registered users that stores for each registered user, a user ID of the registered user and a set of user IDs of registered users who are directly connected to the registered user. In accordance with an alternative embodiment of the present invention, a method for transmitting and receiving content across multiple platforms is provided comprising: creating content; selecting destinations for the content, wherein the destinations comprise: registered users, unregistered users, groups of users, premium groups of users, groups of specific experts, basic users, premium users, anyone user, or companies, websites, social networks; and transmitting the content to the destination.

In accordance with one or more embodiments of the present invention, a system and method for the transmission and reception of content may comprise: a publication module configured to publish content; a personal profile module configured for creation, editing, storing, and displaying personal information, wherein the personal information may comprise, for example an expertise indication, a work history summary, an education summary, a title, a company name, contact information, or the like; a best practices publication module configured to publish best practices company pages, wherein company pages may be Internet web pages or any other method of displaying information; a point of view (“POV”) module for creation of POVs, wherein a POV is a fact-based or an opinion-based submission, for example, a POV on brainstorming new product food categories, or the like. In accordance with one or more embodiments of the present invention, the personal profile module may be configured to alert all connections of a change to a specific personal profile or group of profiles.

In accordance with one or more embodiments of the present invention, a community module may be provided and configured for creating, editing, storing, and displaying information on a group of users or a “community” who may have a common interest. For example, a community may comprise a Brainstorming community, a Food innovation community, or the like. In accordance with one or more embodiments of the present invention, the system and method for the transmission and reception of content may comprise: a syndicated news feed module configured to receive and display electronic feeds of related data and a blog aggregation module configured to receive and display electronic feeds of specific blogs or groups of blogs.

In accordance with one or more embodiments of the present invention, a system and method for the transmission and reception of content may comprise: an electronic forums module, configured to allow users to submit, post, edit, comment on, reply to, and display content based on a specific topic, for example, a Question Forum or the like. In accordance with one or more embodiments of the present invention, a system and method for the transmission and reception of content may comprise user IDs, wherein user IDs may be any string of characters or any electronic signal configured to distinguish one user or group of users from another user or group of users.

In accordance with one or more embodiments of the present invention, a system and method for the transmission and reception of content may comprise groups, wherein groups may be configured to combine groups of users based on predefined or user-selected criteria. In accordance with one or more embodiments of the present invention, a system and method for the transmission and reception of content may comprise a publishing module, wherein the publishing module may be configured to allow users to create, edit, transmit, receive, and display any content over an electronic communication means, for example, via Internet web pages or electronic mail. In accordance with one or more embodiments of the present invention, a system and method for the transmission and reception of content may comprise a company page module, for allowing the creation of a central page for providing access to members of a specific company, or a singular company page operated by a single user, wherein the single user is a representative of the company and is authorized to post content on the company's behalf.

In accordance with one or more embodiments of the present invention, a system and method for the transmission and reception of content may comprise a content submission module configured to allow users to submit content to all contacts in a contact list, wherein the contact list is configured in accordance with any embodiment of the present invention. In accordance with one or more embodiments of the present invention, content may comprise, for example, presentations, whitepapers, articles, or the like. In accordance with one or more embodiments of the present invention, a system and method for the transmission and reception of content may comprise a tech talk module configured to allow users to post electronic messages and content related to a single topic, for example, information relating to new technologies and new innovations.

In accordance with one or more embodiments of the present invention, a system and method for the transmission and reception of content may comprise an opportunities module configured to allow users to post information relating to a single business topic, for example, information relating to new business ideas, partnership opportunities, investment opportunities, supplier relationship opportunities, consulting opportunities, requests for proposals, or the like.

In accordance with one or more embodiments of the present invention, a system and method for the transmission and reception of content may comprise a webinars and conferences module configured to transmit electronic information regarding a meeting conducted by a user or a group of users at a remote location, wherein the electronic information may comprise streaming live or recorded video or audio or a text transcript of a specific meeting. The meeting may comprise, for example, a conference or a webinar. In accordance with one or more embodiments of the present invention, a system and method for the transmission and reception of content may comprise an advertisement module for creation, transmission and displaying of advertisements.

In accordance with one or more embodiments of the present invention, a system and method for the transmission and reception of content may comprise a product or service announcement module configured to transmit or broadcast information regarding company or individual-specific announcements regarding products or services, wherein the announcements may comprise pricing information, technical specifications, availability, launch dates, production dates, or the like. In accordance with one or more embodiments of the present invention, a system and method for the transmission and reception of content may comprise a module related to insights, ideas, and trends configured to transmit, receive, and display information from a user or group of users related to insights, ideas and trends.

In accordance with one or more embodiments of the present invention, a system and method for the transmission and reception of content may comprise a contact addition module configured to add all contacts a user or group of users have in electronic form to the network, regardless if they are a registered user or not. In accordance with one or more embodiments of the present invention, a system and method for the transmission and reception of content may comprise an Events module, configured to receive, transmit, broadcast, display, or the like information relating to events relevant to an individual or a group of individuals, for example, a networking event relating to one or more users. In accordance with one or more embodiments of the present invention, a system and method for the transmission and reception of content may comprise a reviews module, configured for receiving, transmitting, displaying, or the like electronic reviews of products, business practices, systems, methods, or the like. In accordance with one or more embodiments of the present invention, a system and method for the transmission and reception of content may comprise a chat module configured to allow users to chat over an electronic medium, for example a chat Internet webpage. In accordance with one or more embodiments of the present invention, a system and method for the transmission and reception of content may comprise an instant messaging module configured to allow users or groups of users to send electronic messages to each other instantaneously.

FIGS. 8A-8F depict user interfaces to access various exemplary systems and methods for the transmission and reception of content in accordance with embodiments of the present invention. In particular, FIGS. 8A-8F depict various exemplary embodiments of the present invention as described in FIGS. 3 and 5-7.

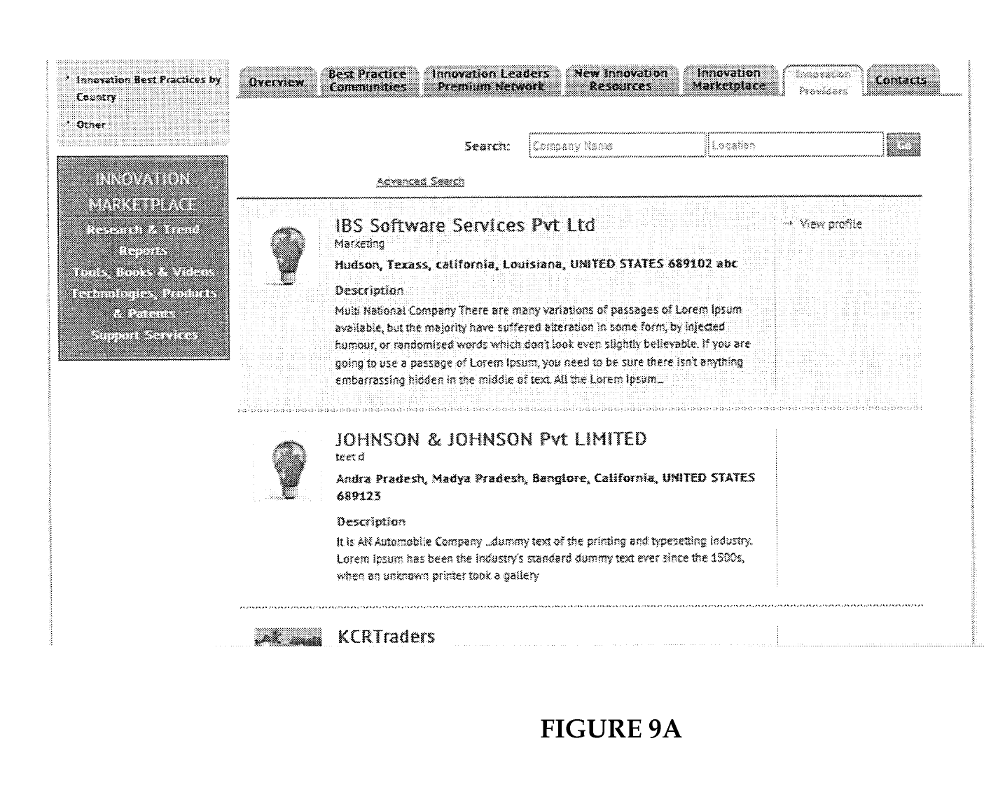

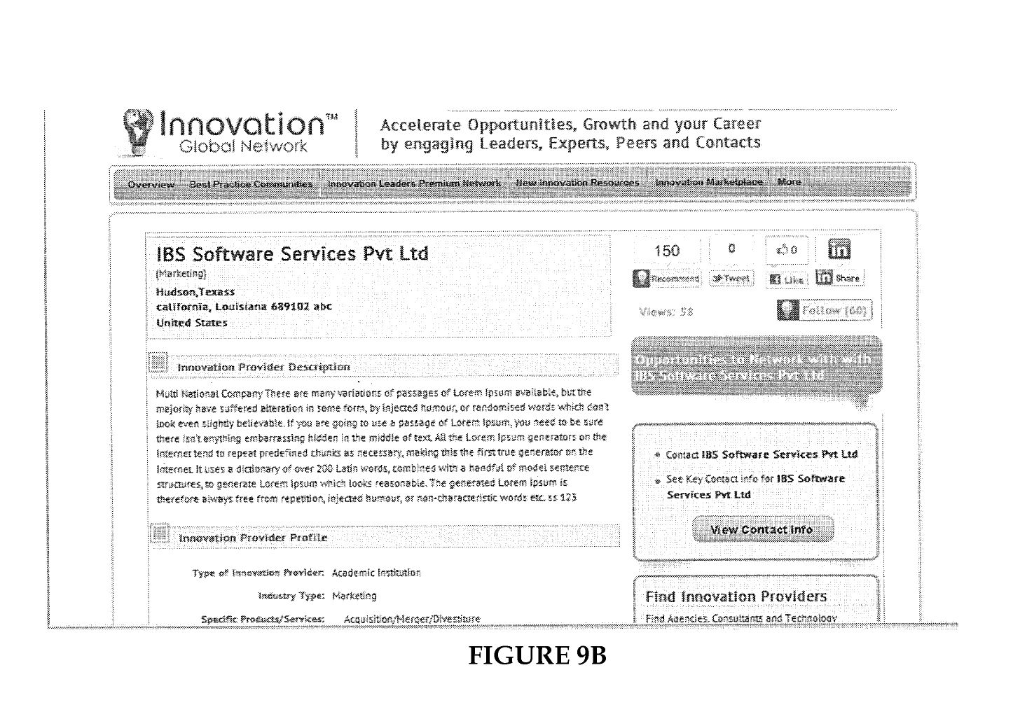

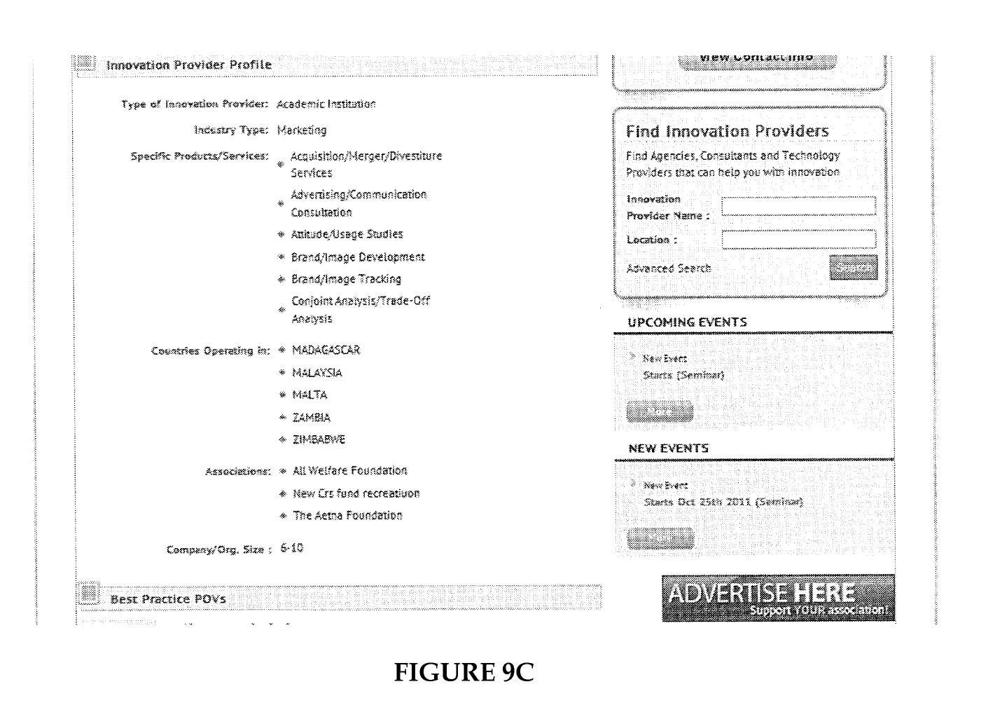

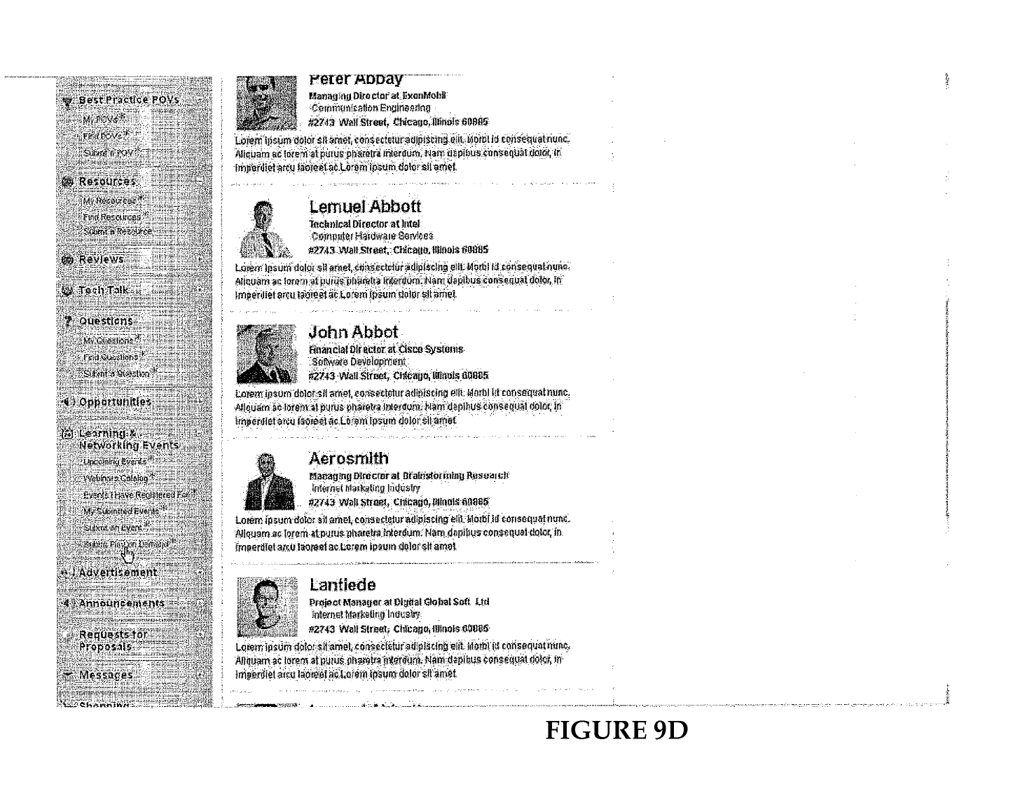

FIGS. 9A-9D depict user interfaces to access various exemplary systems and methods for the transmission and reception of content in accordance with embodiments of the present invention. In particular, FIGS. 9A-9D depict various exemplary embodiments of the present invention as described in FIGS. 3-7.

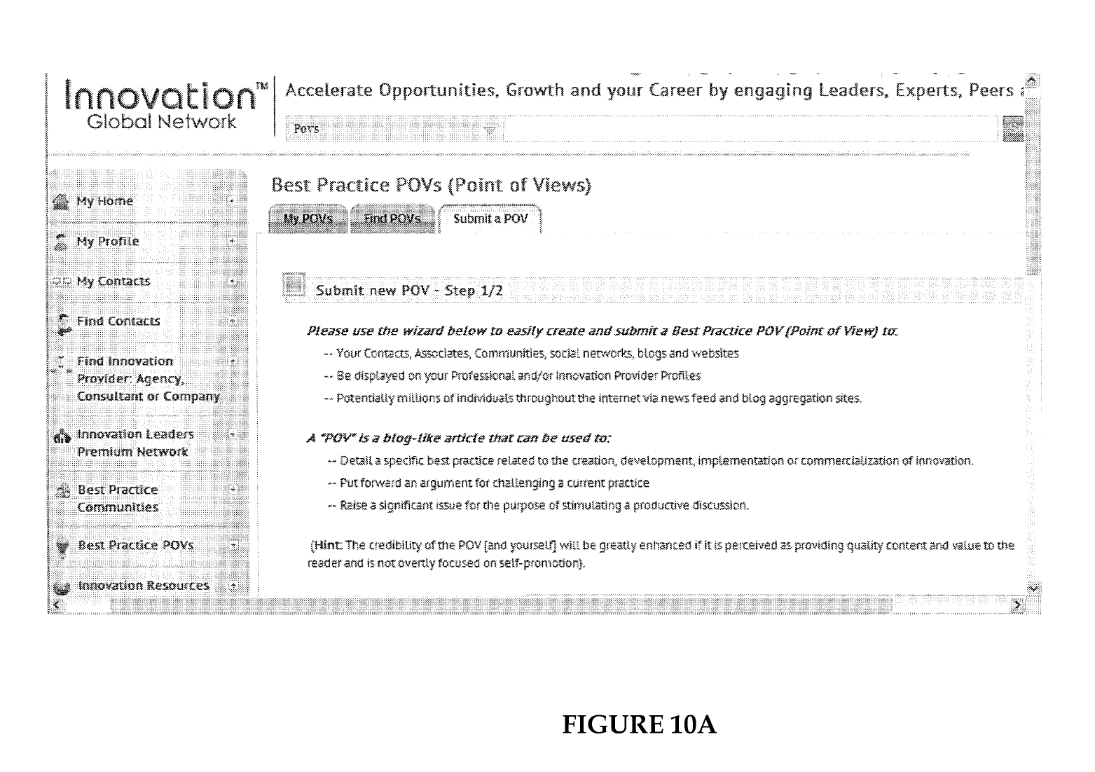

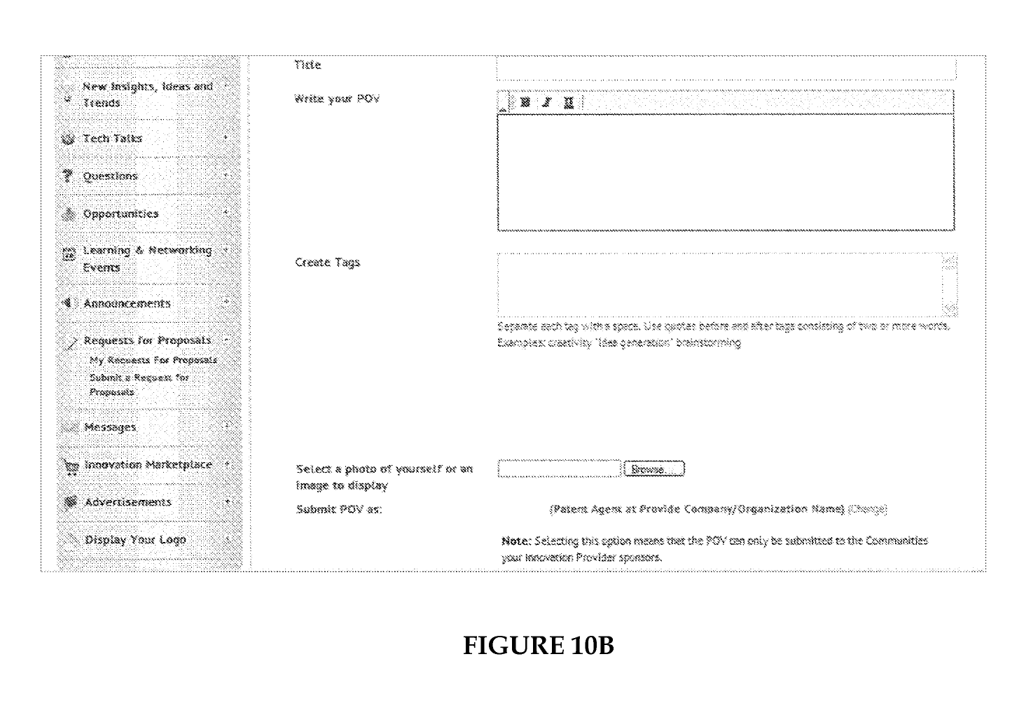

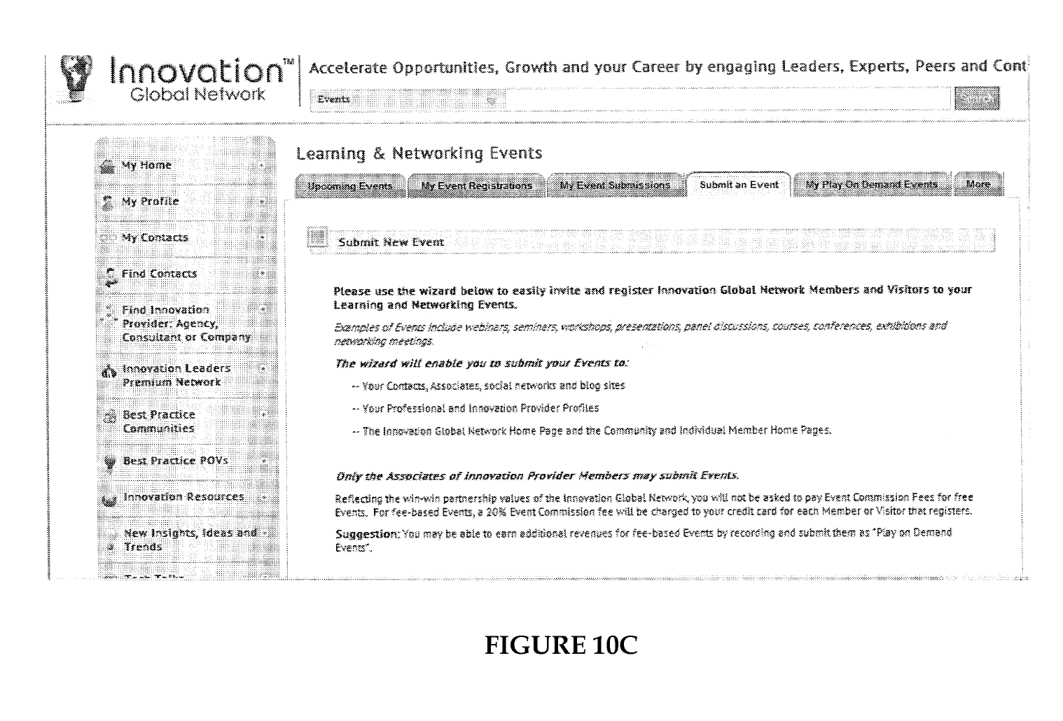

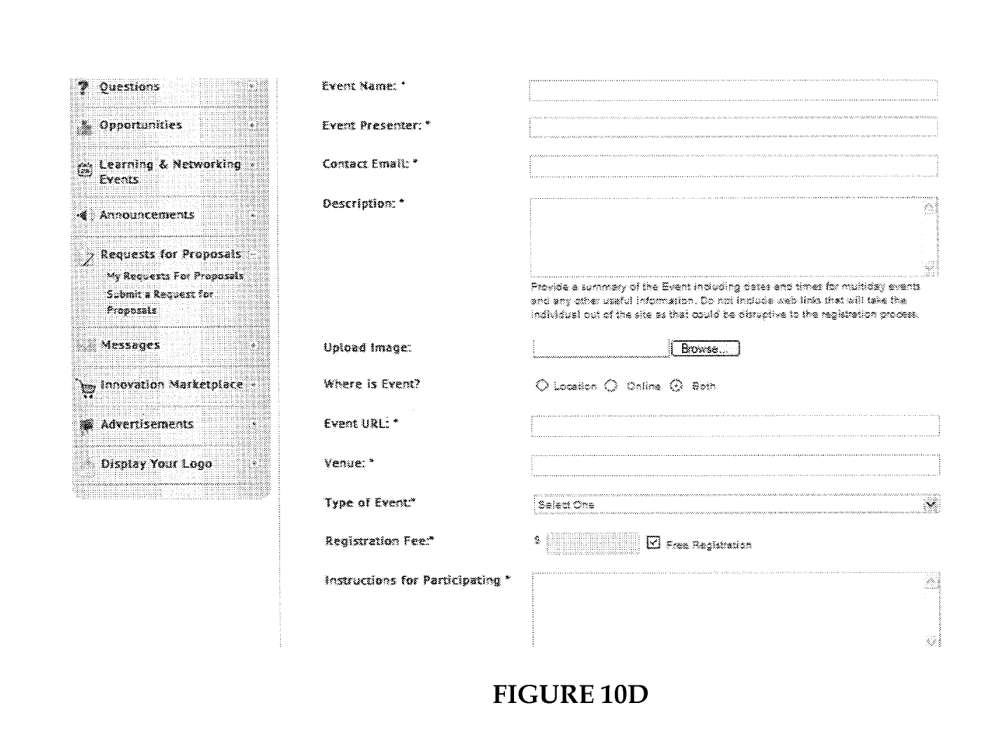

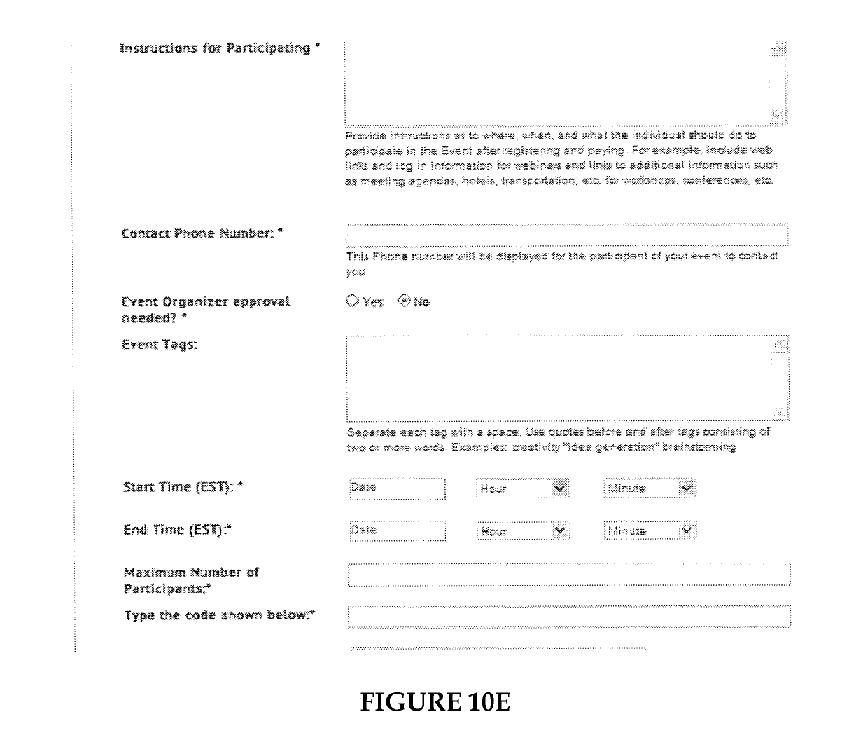

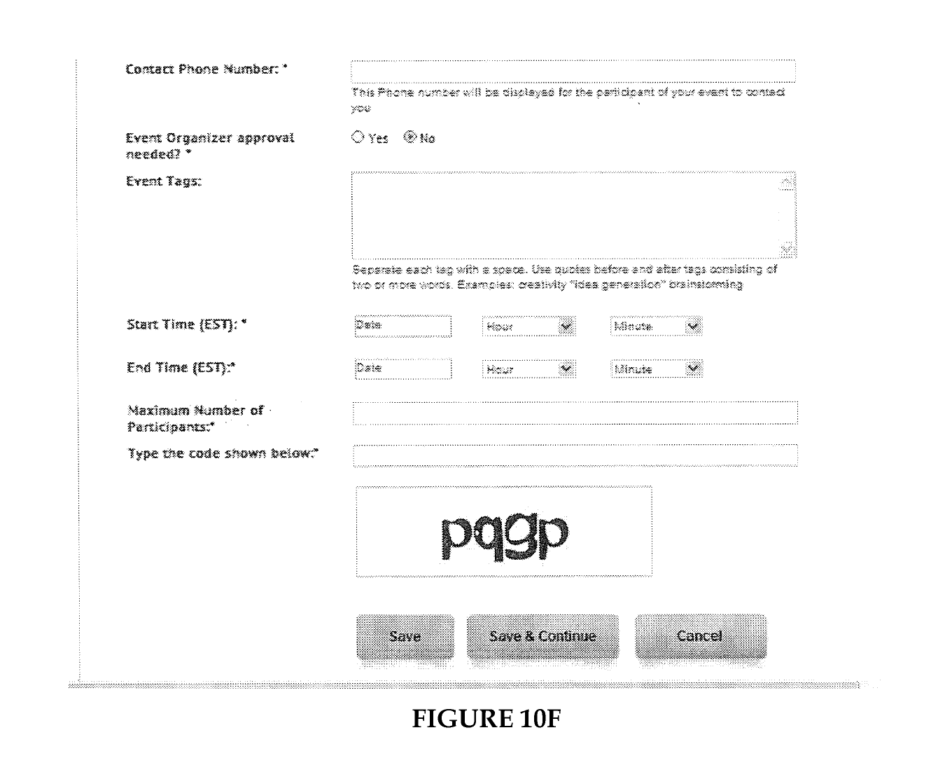

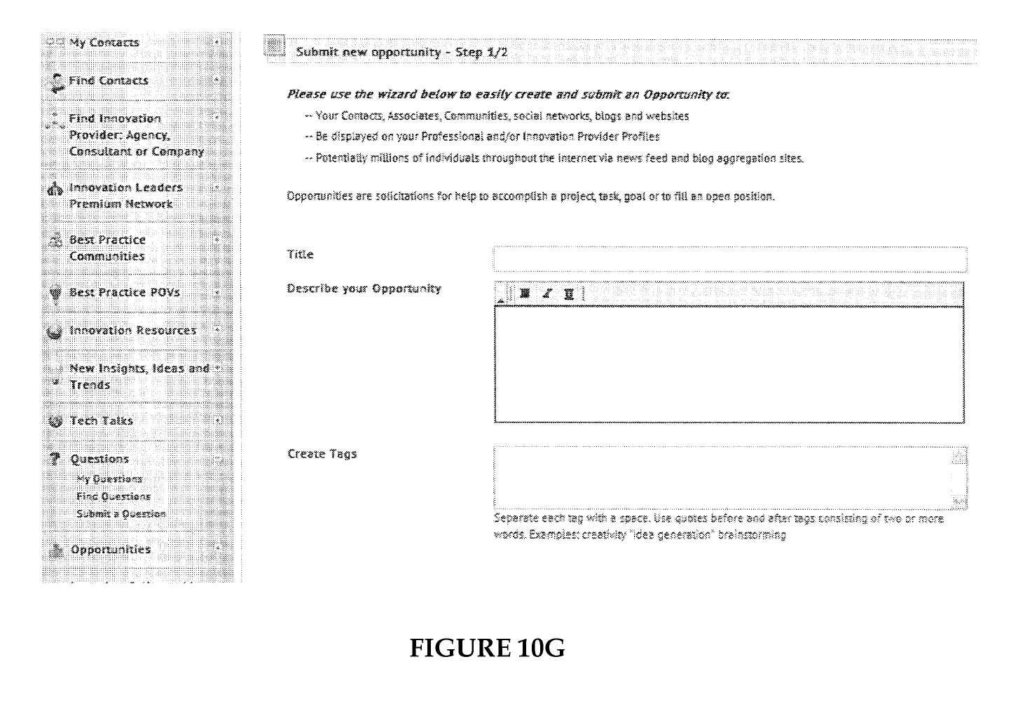

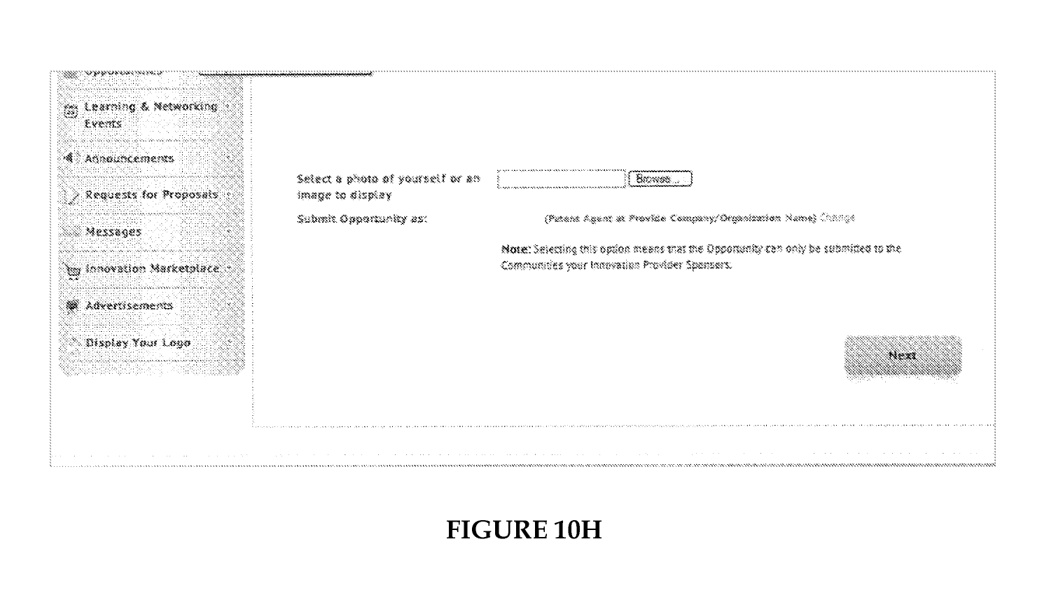

FIGS. 10A-10H depict user interfaces to access various exemplary systems and methods for the transmission and reception of a content submission in accordance with embodiments of the present invention. In particular, FIGS. 10A-10H depict various exemplary embodiments of the present invention as described in FIGS. 3-5 and 7.

FIGS. 10A-10B depict a first user interface for submitting a content submission regarding a Best Practice POV in accordance with an embodiment of the present invention. FIGS. 10C-10F depict a first user interface for submitting a content submission regarding an event in accordance with an embodiment of the present invention. FIGS. 10G-10H depict a first user interface for submitting a content submission regarding a new opportunity in accordance with an embodiment of the present invention.

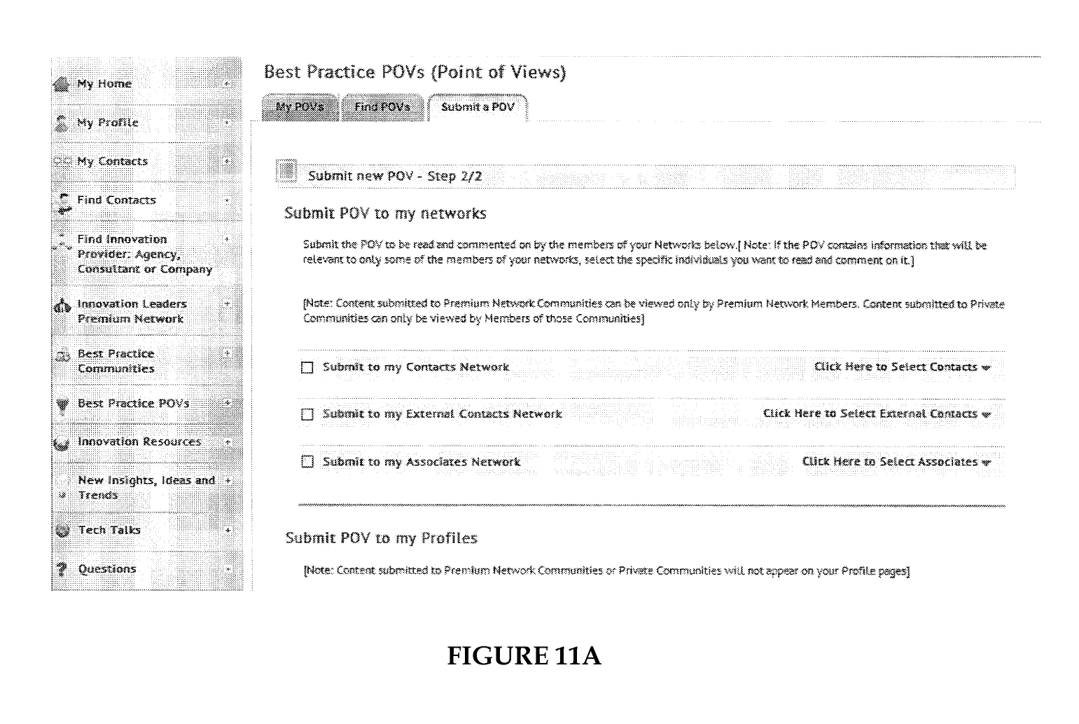

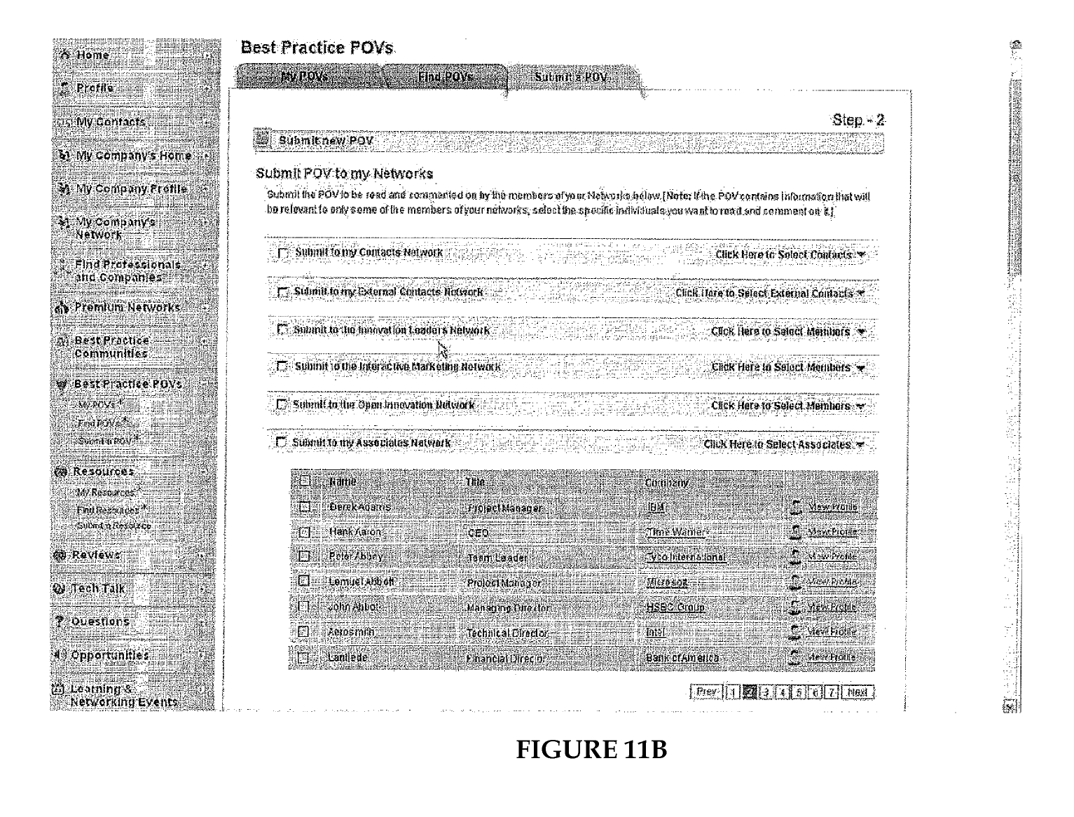

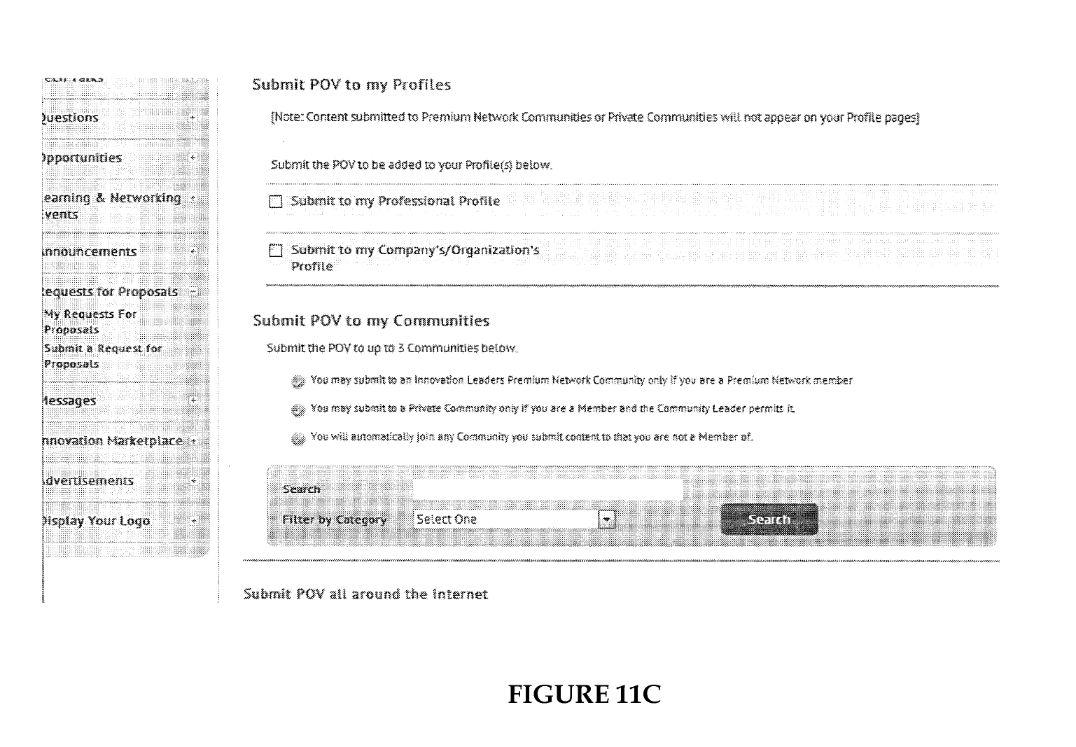

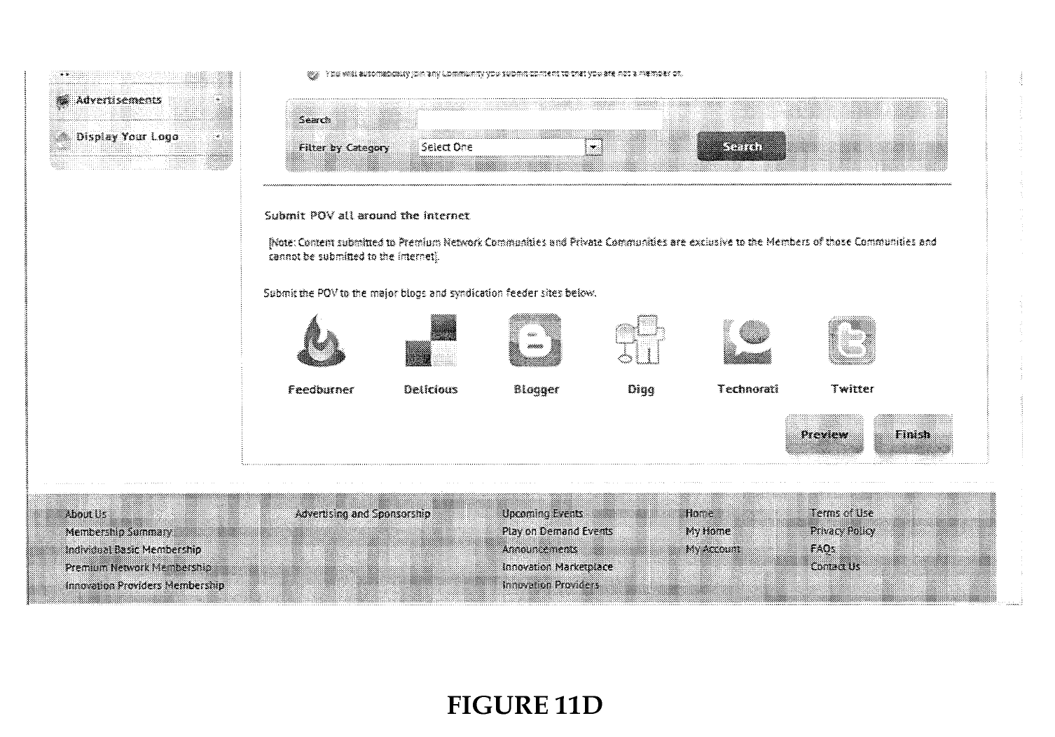

FIGS. 11A-11D depict user interfaces to access various exemplary systems and methods for the transmission and reception of content in accordance with embodiments of the present invention. In particular, FIGS. 11A-11D depict various exemplary embodiments of the present invention as described in FIGS. 3-5 and 7. Specifically, FIGS. 11A-11D illustrate the first user's ability to select one or more networks, communities or profiles as a destination for a content submission.

While the foregoing is directed to embodiments of the present invention, other and further embodiments of the present invention may be devised without departing from the basic scope thereof. It is understood that various embodiments described herein may be utilized in combination with any other embodiment described, without departing from the scope contained herein. Further, the foregoing description is not intended to be exhaustive or to limit the present invention to the precise form disclosed. Modifications and variations are possible in light of the above teachings or may be acquired from practice of the present invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

What is claimed is:

1. A method for the transmission and reception of content implemented in a central server, the steps comprising:
receiving at the central server, from a first user, a content submission;
receiving at the central server, from the first user, an indication of at least one destination of the content submission; and
transmitting the content submission to at least a second user and the at least one destination.

2. The method of claim 1, wherein the second user is an unregistered user.

3. The method of claim 1, wherein the at least one destination comprises at least a social networking website.

4. The method of claim 1, further comprising: receiving a reply to the content submission; and transmitting the reply to at least the second user.

5. The method of claim 1, wherein the first user is a consultant and the second user is a corporate professional.

6. The method of claim 1, wherein the at least one destination further comprises at least one of an internal network contact, an external network contact, a registered user, or an unregistered user.

7. The method of claim 1, wherein the at least one destination further comprises a selection of at least one of a premium network community, a private community, or an open network community.

8. The method of claim 1, wherein the content submission comprises an engagement tool.

9. The method of claim 8, wherein the content submission further comprises a best practice.

10. A method for providing a growth opportunity based on the transmission and reception of content in a central server, the steps comprising:
receiving at the central server, from a first user, an invitation designating a contact list;
receiving, from the first user, a content submission;
associating the first user with at least a second user from the contact list to create the growth opportunity; and
transmitting an alert to at least the second user indicating the growth opportunity.

11. The method of claim 10, wherein the second user is an unregistered user.

12. The method of claim 10, wherein the first user is a consultant and the second user is a corporate professional.

13. The method of claim 10, wherein the contact list comprises at least one of an internal network contact, an external network contact, a registered user, or an unregistered user.

14. The method of claim 10, wherein the content submission comprises an engagement tool.

15. A system for transmitting and receiving content comprising:
a content submission module configured to receive at a central server, from a first user, a content submission; and
a submission process module configured to:
receive at the central server, from the first user, an indication of at least one destination of the content submission; and
transmit the content submission to at least a second user and the at least one destination.

16. The system of claim 15, wherein the second user is an unregistered user.

17. The system of claim 15, wherein the first user is a consultant and the second user is a corporate professional.

18. The system of claim 15, wherein the at least one destination further comprises at least one of an internal network contact, an external network contact, a registered user, or an unregistered user.

19. The system of claim 15, wherein the at least one destination further comprises a selection of at least one of a premium network community, a private community, or an open network community.

20. The system of claim 15, wherein the content submission comprises an engagement tool.
